(19) United States
(12) Patent Application Publication
(10) Pub. No.: US 2026/0001355 A1
(43) Pub. Date: Jan. 1, 2026

(54) LIQUID EJECTING APPARATUS, LIQUID EJECTING METHOD, AND MEDIUM

(71) Applicant: BROTHER KOGYO KABUSHIKI KAISHA, Nagoya (JP)

(72) Inventor: Koki TAWADA, Nagoya (JP)

(73) Assignee: BROTHER KOGYO KABUSHIKI KAISHA, Nagoya (JP)

(21) Appl. No.: 19/246,898

(22) Filed: Jun. 24, 2025

(30) Foreign Application Priority Data
Jun. 26, 2024 (JP) 2024-103023

(51) Int. Cl. B41J 11/62; B41J 2/165; B41J 2/21; B41J 29/377; G06K 15/10

(52) U.S. Cl. CPC B41J 11/62; B41J 2/1652; B41J 2/2103; B41J 2/2142; B41J 29/377; G06K 15/107; B41J 2002/16573

(57) ABSTRACT

A liquid ejecting apparatus includes: first and second ejection heads; a conveyor; a carriage; and a controller. The controller is configured to execute: a risk obtaining process of obtaining information on drying risk of a liquid; a mask selecting process of selecting one mask of a plurality of masks depending on the drying risk; and a printing process. Each of the plurality of masks defines first and second ratios. The first ratio is a ratio of increasing toward a first side in a conveyance direction of a first use-permission rate. The second ratio is a ratio of decreasing toward the first side in the conveyance direction of a second use-permission rate. The first ratio is different from each other among the plurality of masks, and the second ratio is different from each other among the plurality of masks.

### REFERENCE TO RELATED APPLICATIONS

This application claims priority from Japanese Patent Application No. 2024-103023 filed on Jun. 26, 2024. The entire content of the priority application is incorporated herein by reference.

### BACKGROUND ART

A known liquid ejecting apparatus has heads which eject inks of special colors such as red, green, blue, and gold, in addition to heads which eject inks of process colors such as cyan, magenta, yellow, and black. According to such a liquid ejecting apparatus, in a case where printing is performed based on image data of RGB values, a print image with high reproducibility with respect to the image data can be obtained.

### SUMMARY

However, the use frequency of the inks of the special colors is generally lower than the use frequency of the inks of the process colors, and the inks of special colors dry easily in nozzles. Therefore, ejection defect is likely to occur in the nozzle ejecting the ink of the special color.

Accordingly, the present disclosure aims to provide a liquid ejecting apparatus, a liquid ejecting method, and a medium each capable of reducing occurrence of ejection defect from a nozzle.

A first aspect of the present disclosure is a liquid ejecting apparatus including:
a first ejection head having a plurality of first nozzles;
a second ejection head having a plurality of second nozzles;
a conveyor, a recording medium being conveyed by the conveyor in a conveyance direction with respect to the first ejection head and the second ejection head;
a carriage, the first ejection head and the second ejection head being moved by the carriage in a movement direction crossing the conveyance direction; and
a controller.

The first ejection head and the second ejection head are disposed so that a part of the plurality of first nozzles and a part of the plurality of second nozzles overlap with each other in the conveyance direction in a joint area.

The controller is configured to execute:
a risk obtaining process of obtaining information on drying risk of a liquid in the part of the plurality of first nozzles and the part of the plurality of second nozzles;
a mask selecting process of selecting one mask of a plurality of masks depending on the drying risk; and
a printing process of performing printing based on a print job by using the selected one mask.

Each of the plurality of masks defines a first ratio and a second ratio.

The first ratio is a ratio of increasing toward a first side in the conveyance direction of a first use-permission rate, the first use-permission rate being a rate of a number of a nozzle to be used in ejecting of the liquid in a row to a number of the first nozzles arranged in the moving direction in the row, the first nozzles being included in the part of the plurality of first nozzles.

The second ratio is a ratio of decreasing toward the first side in the conveyance direction of a second use-permission rate, the second use-permission rate being a rate of a number of a nozzle to be used in ejecting of the liquid in a row to a number of the second nozzles arranged in the moving direction in the row, the second nozzles being included in the part of the plurality of second nozzles.

The first ratio is different from each other among the plurality of masks, and the second ratio is different from each other among the plurality of masks.

A second aspect of the present disclosure is a liquid ejecting method using a liquid ejecting apparatus.

The liquid ejecting apparatus includes:
a first ejection head having a plurality of first nozzles;
a second ejection head having a plurality of second nozzles;
a conveyor, a recording medium being conveyed by the conveyor in a conveyance direction with respect to the first ejection head and the second ejection head;
a carriage, the first ejection head and the second ejection head being moved by the carriage in a movement direction crossing the conveyance direction; and
a controller.

The first ejection head and the second ejection head are disposed so that a part of the plurality of first nozzles and a part of the plurality of second nozzles overlap with each other in the conveyance direction in a joint area.

The liquid ejecting method including:
obtaining information on drying risk of a liquid in the part of the plurality of first nozzles and the part of the plurality of second nozzles;
selecting one mask of a plurality of masks depending on the drying risk; and
performing printing based on a print job by using the selected one mask.

Each of the plurality of masks defines a first ratio and a second ratio.

The first ratio is a ratio of increasing toward a first side in the conveyance direction of a first use-permission rate, the first use-permission rate being a rate of a number of a nozzle to be used in ejecting of the liquid in a row to a number of the first nozzles arranged in the moving direction in the row, the first nozzles being included in the part of the plurality of first nozzles.

The second ratio is a ratio of decreasing toward the first side in the conveyance direction of a second use-permission rate, the second use-permission rate being a rate of a number of a nozzle to be used in ejecting of the liquid in a row to a number of the second nozzles arranged in the moving direction in the row, the second nozzles being included in the part of the plurality of second nozzles.

The first ratio is different from each other among the plurality of masks, and the second ratio is different from each other among the plurality of masks.

A third aspect of the present disclosure is a non-transitory and computer-readable medium storing a program executable by a controller in a liquid ejecting apparatus.

The liquid ejecting apparatus includes:
a first ejection head having a plurality of first nozzles;
a second ejection head having a plurality of second nozzles;
a conveyor, a recording medium being conveyed by the conveyor in a conveyance direction with respect to the first ejection head and the second ejection head;
a carriage, the first ejection head and the second ejection head being moved by the carriage in a movement direction crossing the conveyance direction; and
the controller.

The first ejection head and the second ejection head are disposed so that a part of the plurality of first nozzles and a part of the plurality of second nozzles overlap with each other in the conveyance direction in a joint area.

The program is configured to cause the controller to:
obtain information on drying risk of a liquid in the part of the plurality of first nozzles and the part of the plurality of second nozzles;
select one mask of a plurality of masks depending on the drying risk; and
perform printing based on a print job by using the selected one mask.

Each of the plurality of masks defines a first ratio and a second ratio.

The first ratio is a ratio of increasing toward a first side in the conveyance direction of a first use-permission rate, the first use-permission rate being a rate of a number of a nozzle to be used in ejecting of the liquid in a row to a number of the first nozzles arranged in the moving direction in the row, the first nozzles being included in the part of the plurality of first nozzles.

The second ratio is a ratio of decreasing toward the first side in the conveyance direction of a second use-permission rate, the second use-permission rate being a rate of a number of a nozzle to be used in ejecting of the liquid in a row to a number of the second nozzles arranged in the moving direction in the row, the second nozzles being included in the part of the plurality of second nozzles.

The first ratio is different from each other among the plurality of masks, and the second ratio is different from each other among the plurality of masks.

According to the liquid ejecting apparatus, the liquid ejecting method, and the medium of the present disclosure, drying of the liquid in the nozzle in the joint area between the first ejection head and the second ejection head can be reduced by changing the mask depending on the drying risk. Thus, occurrence of ejection defect can be reduced.

### BRIEF DESCRIPTION OF DRAWINGS

FIG. 1 is a schematic view depicting a configuration of a liquid ejecting apparatus.

FIG. 2 is a schematic view depicting a configuration of a plurality of ejection heads in a state that the plurality of ejection heads are mounted on a carriage.

FIG. 3 is a block diagram depicting the configuration of the liquid ejecting apparatus.

FIG. 4A is a schematic view for describing an ordinary mask, and FIG. 4B is a schematic view for describing a special mask A.

FIG. 5A is a schematic view for describing a special mask B, and FIG. 5B is a schematic view for describing a special mask C.

FIGS. 6A and 6B are flow charts indicating an example of an operation of the liquid ejecting apparatus in a printing process.

FIGS. 7A and 7B are flow charts indicating an example of a mask setting process.

FIG. 8 is a flow chart indicating another example of the mask setting process.

FIG. 9 is a flow chart indicating another example of the mask setting process.

FIG. 10 is a flow chart indicating another example of the mask setting process.

FIGS. 11A and 11B are flow charts indicating another example of the mask setting process.

FIG. 12 is a flow chart indicating another example of the mask setting process.

FIGS. 13A to 13C are each schematic views for describing the kind of mask and the conspicuousness of a banding in a case where the banding exists in a joint area due to positional deviation in the front-rear direction between a first ejection head and a second ejection head.

### DESCRIPTION

A liquid ejecting apparatus, a liquid ejecting method, and a medium according to an embodiment of the present disclosure will be described below, with reference to drawings. The concept of direction used in the following description is used for convenience of the description, and does not limit the orientation of each of the disclosed configurations to such a direction. Further, the liquid ejecting apparatus described below is merely an embodiment of the present disclosure. Therefore, the present disclosure is not limited to the following embodiment, and the configuration can be added, deleted, or changed within a range not deviating from the purpose of the disclosure.

### (Configuration of Liquid Ejecting Apparatus)

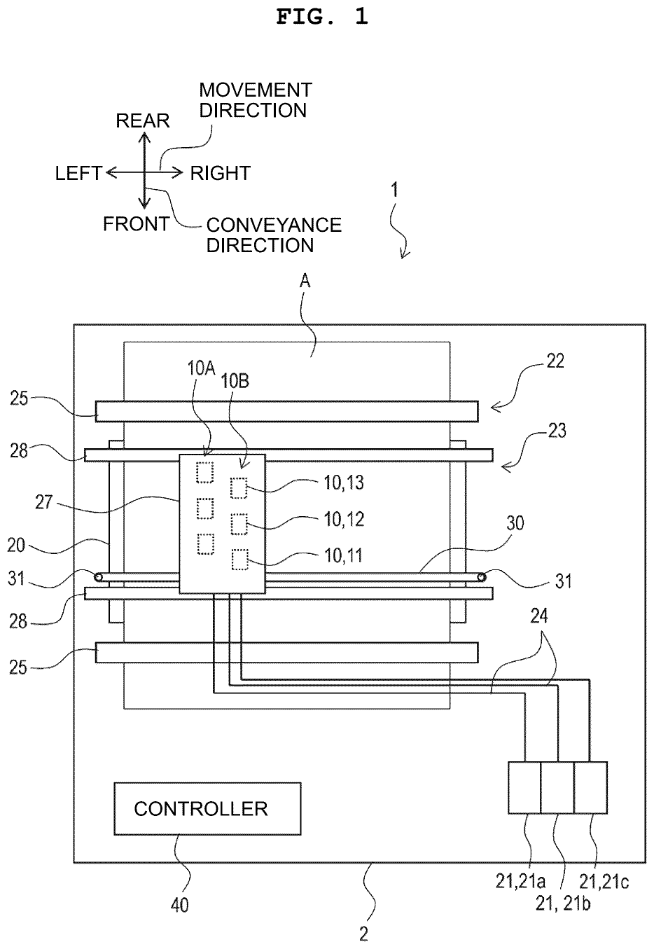

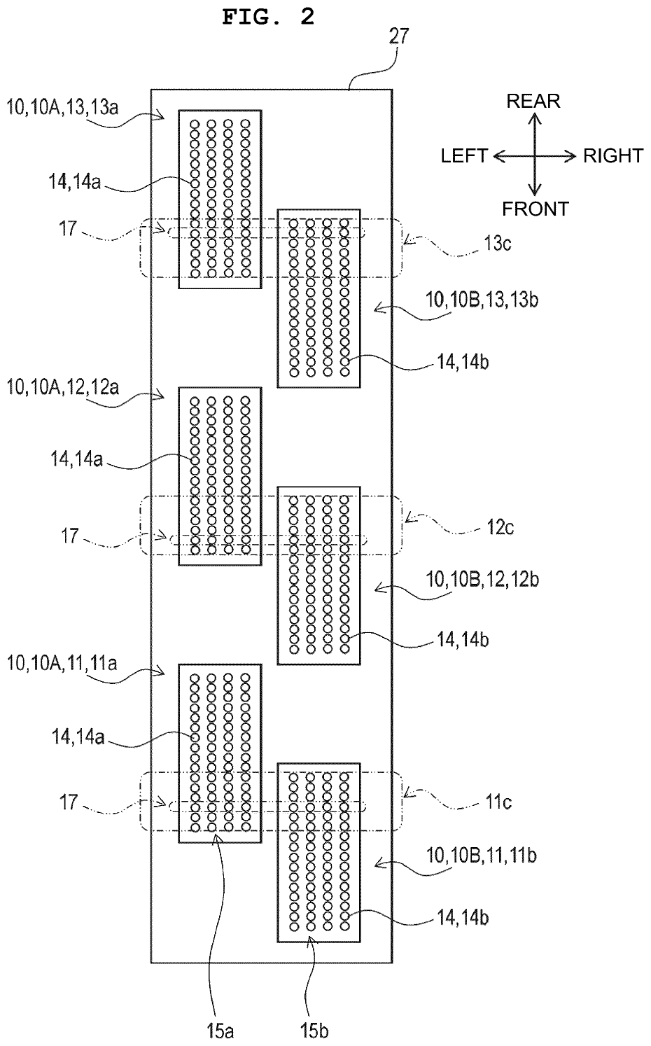

FIG. 1 is a schematic view depicting a configuration of a liquid ejecting apparatus 1 according to the present embodiment. As depicted in FIG. 1, the liquid ejecting apparatus 1 is an apparatus configured to eject a liquid, such as an ink, etc., from nozzles 14 (FIG. 2) of ejection heads 10 to a recording medium A so as to form an image on the recording medium A. Although an example in which the liquid ejecting apparatus 1 is applied to an ink-jet printer will be described in the following, the present disclosure is also applicable to another use.

The liquid ejecting apparatus 1 is of the serial head system and includes, for example, a plurality of ejection heads 10, a platen 20, a plurality of tanks 21, a conveying device 22, and a moving device 23. Note that a conveyance direction in which the recording medium A is conveyed by the conveying device 22 is referred to as the front-rear direction. Further, a movement direction crossing the conveyance direction is referred to as the left-right direction. Furthermore, a direction crossing both the conveyance direction and the movement direction is referred to as the up-down direction. However, the directions related to the liquid ejecting apparatus 1 are not limited to the directions as described above.

The plurality of ejection heads 10 includes two color heads 11, two special color heads 12, and two white background heads 13. The details of each of the plurality of ejection heads 10 will be described later, with reference to FIG. 2.

The platen 20 is a member having a shape of a plate with a flat upper surface, and defines a distance between the recording medium A placed on the upper surface of the platen 20 and the lower surface of each of the plurality of ejection heads 10 disposed to face the recording medium A. The plurality of tanks 21 are each a container configured to store the liquid to be supplied to the plurality of ejection heads 10 via elastic tubes 24, and the plurality of tanks 21 are disposed so that the number of the tanks 21 is the same as or more than the number of kinds of the liquid. For example, the plurality of tanks 21 includes a tank 21a configured to store an ink of a process color (hereinafter also referred to as “process color ink” in some cases) to be supplied to the color heads 10a, a tank 21b configured to store an ink of a special color (hereinafter also referred to as “special color ink” in some cases) to be supplied to the special color heads 10b, and a tank 21c configured to store a white background ink to be supplied to the white background heads 10c.

Examples of the process color ink include inks of respective colors which are cyan, magenta, yellow and black. Examples of the special color ink include inks of special color which are red, green, blue and gold, etc., and different from the process color. Examples of the white background ink include a white ink.

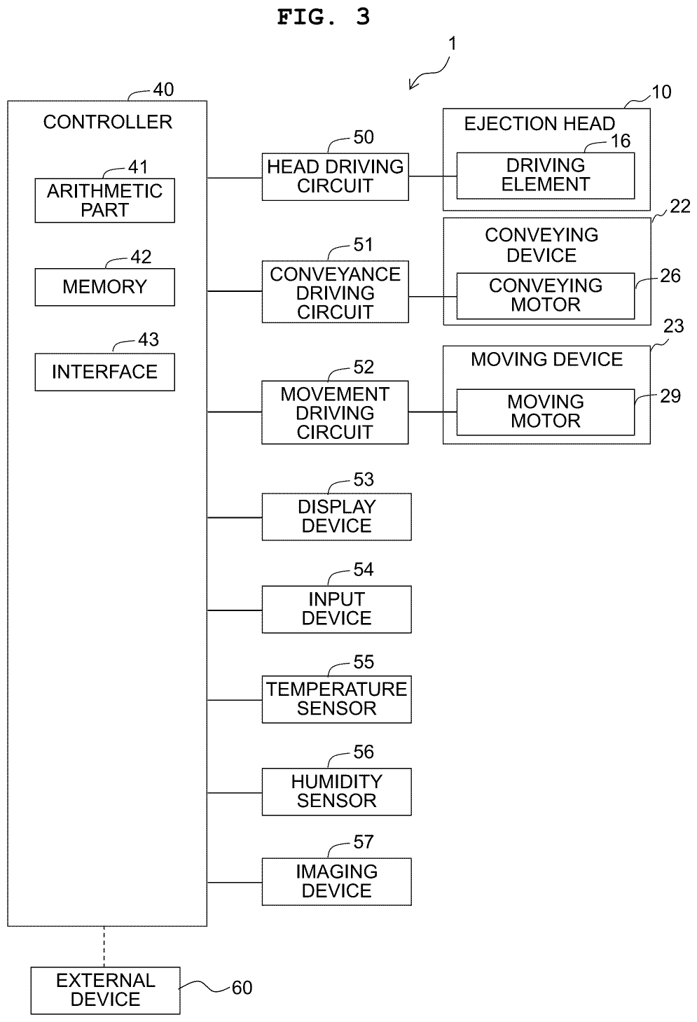

The conveying device 22 has, for example, two conveying roller pairs 25, 25, and a conveying motor 26 (FIG. 3). Each of the two conveying roller pairs 25, 25 has a configuration in which two rollers, each having an axis extending in the left-right direction, are disposed in the up-down direction so as to form a pair. The rotating shaft of the conveying motor 26 is connected to one of the two rollers, and the two rollers rotate by the driving of the conveying motor 26. Such two conveying roller pairs 25, 25 are disposed apart from each other in the front-rear direction, with the center position of the platen 20 being interposed between the two conveying roller pairs 25, 25. The recording medium A is conveyed in the front-rear direction in accordance with the driving of the conveying motor 26, in a state that the recording medium A is held between the upper and lower rollers of the two conveying roller pairs 25, 25.

The moving device 23 includes a carriage 27, two guide rails 28, a moving motor 29 (FIG. 3), and an endless belt 30. The two guide rails 28 extend in the left-right direction at a position above the platen 20 so that the ejection heads 10 are interposed between the two guide rails 28 in the front-rear direction. The carriage 27 has the ejection heads 10 mounted on the carriage 27 and is supported by the two guide rails 28 to be movable in the left-right direction. The endless belt 30 extends in the left-right direction and is wound around pulleys 31, 31 which are disposed to the left and to the right with respect to the platen 20. A part of the endless belt 30 is connected to the carriage 27, and a rotating shaft of the moving motor 29 is connected to one of the pulleys 31, 31. Therefore, as the moving motor 29 is driven, the endless belt 30 runs in the left-right direction, thereby causing the carriage 27 to reciprocatively move in the left-right direction along the two guide rails 28. With this, the ejection heads 10 mounted on the carriage 27 are movable in the left-right direction.

### (Ejection Head)

FIG. 2 is a schematic view depicting the configuration of the plurality of ejection heads 10 in a state that the plurality of ejection heads 10 is mounted on the carriage 27. As described above, the plurality of ejection heads 10 includes the two color heads 11, the two special color heads 12, and the two white background heads 13. More specifically, the two color heads 11 include a first color head 11a and a second color head 11b constructing a pair, the two special color heads 12 include a first special color head 12a and a second special color head 12b constructing a pair, and the two white background heads 13 include a first white background head 13a and a second white background head 13b constructing a pair.

Among the above-described heads, at least the first color head 11a and the first special color head 12a construct a first ejection head 10A according to the present disclosure, and the second color head 11b and the second special color head 12b construct a second ejection head 10B according to the present disclosure. Note that in the following description, the first white background head 13a is also included in the first ejection head 10A, and the second white background head 13b is also included in the second ejection head 10B. The first ejection head 10A may correspond to at least one of the first color head 11a, the first special color head 12a, or the first white background head 13a. The second ejection head 10B may correspond to at least one of the second color head 11b, the second special color head 12b, or a second white background head 13b.

Although the color heads 11 are only exemplified by the pair of the first color head 11a and the second color head 11b in the present embodiment, in a case where a plurality of types of ink is used as the process color ink, such a configuration is also possible wherein the pair, of the first color head 11a and the second color head 11b, is disposed as many as or more than the number of types of the process color ink to be used. Similarly, although the special color heads 12 are only exemplified by the pair of the first special color head 12a and the second special color head 12b here, in a case where a plurality of types of ink are used as the special color ink, such a configuration is also possible wherein the pair, of the first special color head 12a and the second special color head 12b, is disposed as many as or more than the number of types of the special color ink to be used.

Each of the ejection heads 10 has a plurality of nozzles 14. The first ejection head 10A has a plurality of nozzle arrays 15a in each of which the plurality of first nozzles 14a is aligned in the front-rear direction, and the plurality of nozzle arrays 15a is disposed side by side in the left-right direction. The second ejection head 10B has a plurality of nozzle arrays 15b in each of which the plurality of second nozzles 14b is aligned in the front-rear direction, and the plurality of nozzle arrays 15b is disposed side by side in the left-right direction.

The first ejection head 10A and the second ejection head 10B configured to eject the same kind of liquid are positioned being shifted from each other in the front-rear direction and the left-right direction. Specifically, the first color head 11a is positioned to the left and to the rear of the second color head 11b. Further, the first color head 11a and the second color head 11b do not overlap with each other with respect to the positions in the left-right direction, but partially overlap with each other with respect to the positions in the front-rear direction so as to form a joint area (color joint area) 11c. In this joint area 11c, the positions of a part of the plurality of first nozzles 14a (e.g., first nozzles 14a as many as a predetermined number N from a front end) of the first color head 11a and the positions of a part of the plurality of second nozzles 14b (e.g., second nozzles 14b as many as a predetermined number N from a rear end) of the second color head 11b are overlap in the front-rear direction.

The first special color head 12a is positioned to the left and to the rear of the second special color head 12b. Further, the first special color head 12a and the second special color head 12b do not overlap with each other with respect to the positions in the left-right direction, but partially overlap with each other with respect to the positions in the front-rear direction so as to form a joint area (special color-joint area) 12c. In this joint area 12c, the positions of a part of the plurality of first nozzles 14a (e.g., first nozzles 14a as many as a predetermined number N from a front end) of the first special color head 12a and the positions of a part of the plurality of second nozzles 14b (e.g., second nozzles 14b as many as a predetermined number N from a rear end) of the second special color head 12b are overlap in the front-rear direction.

The first white background head 13a is positioned to the left and to the rear of the second white background head 13b. Further, the first white background head 13a and the second white background head 13b do not overlap with each other with respect to the positions in the left-right direction, but partially overlap with each other with respect to the positions in the front-rear direction so as to form a joint area (white base-joint area) 13c. In this joint area 13c, the positions of a part of the plurality of first nozzles 14a (e.g., first nozzles 14a as many as a predetermined number N from a front end) of the first white background head 13a and the positions of a part of the plurality of second nozzles 14b (e.g., second nozzles 14b as many as a predetermined number N from a rear end) of the second white background head 13b overlap with each other in the front-rear direction.

Note that in the above-described color joint area 11c, the first nozzles 14a and the second nozzles 14b, which overlap with each other as seen along the left-right direction at a certain position in the front-rear direction, form one nozzle row 17 extending in the left-right direction, and the color joint area 11c has a plurality of such nozzle rows 17. Further, the number of the first nozzles 14a constructing each of the nozzle rows 17 and the number of the second nozzles 14b constructing each of the nozzle rows 17 are the same as each other. The special color joint area 12c and the white background joint area 13c also have a plurality of nozzle rows 17 like the above-described plurality of nozzle rows 17, and the number of the first nozzles 14a constructing each of the nozzle rows 17 and the number of the second nozzles 14b constructing each of the nozzle rows 17 are the same as each other.

Each of the plurality of ejection heads 10 as described above has channel parts constructed of a stacked body of a plurality of plates, and driving elements 16. A recessed part or a through hole is formed in each of the plurality of plates, and the plurality of plates are stacked so that the channel parts have inner channels (e.g., a common channel and individual channels) through which the liquid flows up to each of the plurality of nozzles 14. Further, the driving element 16 is an actuator such as a piezoelectric element, a heating element, or an electrostatic actuator, etc. One driving element 16 is disposed with respect to one of the plurality of nozzles 14, and the driving element 16 is configured to apply pressure for ejecting the liquid from the nozzle 14 to the liquid in the individual channel.

### (Other Configurations of Liquid Ejecting Apparatus)

FIG. 3 is a block diagram depicting the configuration of the liquid ejecting apparatus 1. As depicted in FIG. 3, the liquid ejecting apparatus 1 includes a controller 40, and a head driving circuit 50, a conveyance driving circuit 51, a movement driving circuit 52, a display device 53, an input device 54, a temperature sensor 55, a humidity sensor 56, an imaging device 57, etc., which are connected to the controller 40. Further, the controller 40 is configured such that an external device 60 which does not construct the liquid ejecting apparatus 1 is connectable to the controller 40 in a state that the liquid ejecting apparatus 1 can communicate with the external device 60 via a wired or wireless connection.

The controller 40 has, for example, an arithmetic part 41, a memory 42, and an interface 43. The arithmetic part 41 includes at least one circuit among a processor such as an MPU and an integrated circuit such as an ASIC, etc. The arithmetic part 41 controls the operation of each part of the liquid ejecting apparatus 1 by executing a predetermined computer program, and executes various kinds of processes. The details of each of the processes will be described later.

The memory 42 is a memory accessible from the arithmetic part 41, and includes a ROM and a RAM. The ROM stores a computer program (including a liquid ejecting program according to the present disclosure) executable by the arithmetic part 41, and data, etc., needed in a case where the arithmetic part 41 executes the computer program. The RAM temporarily stores various kinds of data, such as data received from the external device 60 (such as image data) and data generated by the arithmetic part 41.

The interface 43 is a communication device configured to transmit and receive data with respect to the external device 60 via a wired or wireless connection. The controller 40 is capable of receiving various kinds of data, such as the image data, from the external device 60 via the interface 43. Examples of the external device 60 include another computer, a camera, a communication network, a recording device, a display, a printer, etc.

The controller 40 is connected to a plurality of driving elements 16 via a head driving circuit 50. The controller 40 outputs a control signal to the head driving circuit 50, and the head driving circuit 50 generates drive signals based on the input control signal and outputs the drive signals to the plurality of driving elements 16, respectively. Each of the plurality of driving elements 16 is driven based on the input drive signal so as to apply ejection pressure to the liquid in the individual channel.

The controller 40 is connected to the conveying motor 26 via the conveyance driving circuit 51. The controller 40 outputs a control signal to the conveyance driving circuit 51, and the conveyance driving circuit 51 generates a drive signal based on the input control signal and outputs the drive signal to the conveying motor 26. The conveying motor 26 is driven based on the input drive signal so as to operate the conveying device 22 and causes the conveying device 22 to convey the recording medium A in the front-rear direction relative to the ejection heads 10.

The controller 40 is connected to the moving motor 29 via the movement driving circuit 52. The controller 40 outputs a control signal to the movement driving circuit 52, and the movement driving circuit 52 generates a drive signal based on the input control signal and outputs the drive signal to the moving motor 29. The movement motor 29 is driven based on the input drive signal to operate the moving device 23, and causes the moving device 23 to move the carriage 27, on which the ejection heads 10 is mounted, in the left-right direction.

The display device 53 is, for example, a liquid crystal display, etc. and configured to display an image to be printed by the liquid ejecting apparatus 1 and various kinds of information under the control of the controller 40. The input device 54 is, for example, a button switch, and a touch panel integrated with the display device 53, etc. Via the input device 54, a user is capable of performing an input operation so as to input various kinds of information (such as an instruction to execute an operation, a setting value, etc.) to the controller 40.

The temperature sensor 55 is a thermometer, etc., which detects information regarding the temperature around the first ejection head 10A and the second ejection head 10B. The temperature sensor 55 may be configured to directly detect the temperature of the liquid inside each of the ejection heads 10, or may be configured to indirectly detect the temperature of the liquid inside each of the ejection heads 10, from the outer surface or the vicinity of each of the ejection heads 10. Further, the configuration of the temperature sensor 55 is not limited to a configuration in which the temperature sensor 55 detects the temperature itself, and the temperature sensor 55 may be configured to detect another parameter (e.g., the viscosity of the liquid, etc.) which correlates with the temperature, and to estimate the temperature through a calculation in the controller 40.

The humidity sensor 56 is, for example, a hygrometer etc. which detects information regarding the humidity around the first ejection head 10A and the second ejection head 10B. The humidity sensor 56 may be configured to directly detect the humidity in the vicinity of the nozzles 14 of each of the ejection heads 10, but the configuration of the humidity sensor 56 is not limited to this. The humidity sensor 56 may be configured to indirectly detect the humidity in the vicinity of the nozzles 14, or to detect another parameter which correlates with the humidity and to estimate the humidity through a calculation in the controller 40.

The imaging device 57 is a device which captures an image printed on the recording medium A by the liquids ejected from the ejection heads 10 within the casing 2 of the liquid ejecting apparatus 1. As the imaging device 57, a digital camera or a scanner including an image sensor such as a CMOS or CCD etc. may be used. The imaging device 57 inputs imaging data obtained by reading the image on the recording medium A to the controller 40.

### (Basic Operation of Printing Process)

In the liquid ejecting apparatus 1, in a case, for example, where the controller 40 receives a print job from the external device 60, the liquid ejecting apparatus 1 executes printing of an image on the recording medium A based on the print job. For example, the controller 40 executes a printing process (pass printing process) of executing an ejecting operation of causing the ejection heads 10 to eject the liquids from the nozzles 14 while causing the moving device 23 to move the ejection heads 10 in the left-right direction, and a conveying operation of causing the conveying device 22 to convey the recording medium A in the front-rear direction.

Here, the liquid ejecting apparatus 1 according to the present embodiment has the two ejection heads 10 configured to eject the same type of liquid and disposed to be shifted from each other in the front-rear direction. Such a configuration is substantially the same as having an ejection head of further elongated size in the front-rear direction, and thus a high-speed printing process can be realized. On the other hand, such a configuration needs to have high precision regarding fixing positions of the two ejection heads 10 to the carriage 27. In a case where the ejection head(s) 10 are/is deviated from the designed position(s), an unintended streak (banding) might occur in the print image, leading to such a concern that the image quality might deteriorate.

In order to deal with this banding, the liquid ejecting apparatus 1 has joint areas 11c to 13c depicted in FIG. 2 disposed between the first ejection heads 10A and the second ejection heads 10B. Further, in each of the joint areas 11c to 13c, a mask is set with respect to the first ejection head 10A and the second ejection head 10B so as to permit each of the first ejection head 10A and the second ejection head 10B to use, in the printing process, only a part of the nozzles 14 for ejecting the liquid. In other words, in each of the joint areas 11c to 13c, the mask is used so that the first ejection head 10A and the second ejection head 10B perform singling printing.

### (Ordinary Mask)

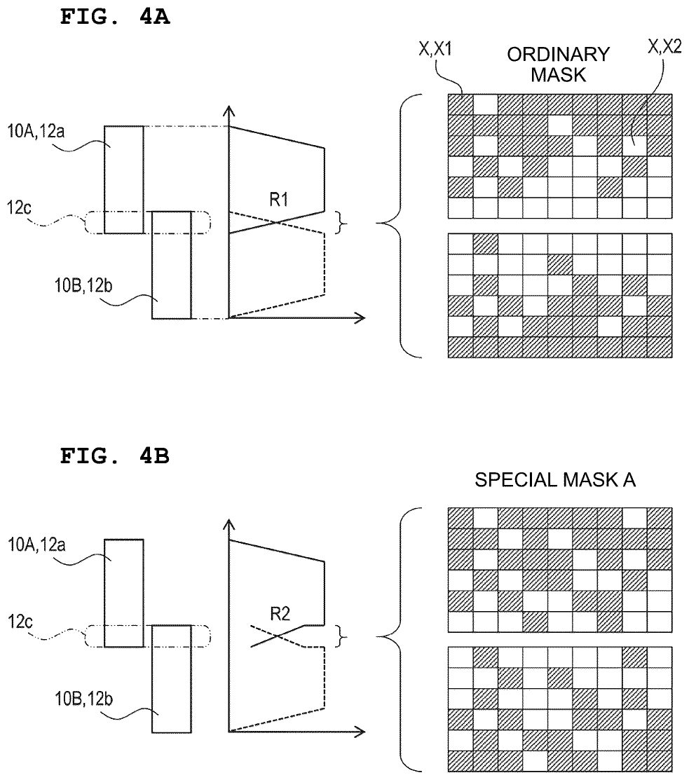

The mask will be described below. Note that information regarding the mask is stored in the memory 42 of the controller 40. FIG. 4A is a schematic view for describing a mask (ordinary mask) for countermeasure against the banding, and illustrates an ordinary mask which is set with respect to the nozzles 14 of the special color-joint area 12c disposed with respect to the first special color head 12a and the second special color head 12b. However, a similar ordinary mask may be set with respect to the color joint area 11c and the white base-joint area 13c other than the special color-joint area 12c. This is similarly applicable to another mask (special masks A, B and C) which will be described later.

Note that the left portion of FIG. 4A depicts a disposing concept of the first special color head 12a and the second special color head 12b. The center of FIG. 4A depicts a graph indicating a use-permission rate (0% to 100%) of the nozzles 14 at each position in the front-rear direction, with the vertical axis representing the positions of the nozzles 14 in the front-rear direction and the horizontal axis representing the use-permission rate. Further, in this graph, an upper graph in solid line corresponds to the first special color head 12a, and a lower graph in dashed line corresponds to the second special color head 12b.

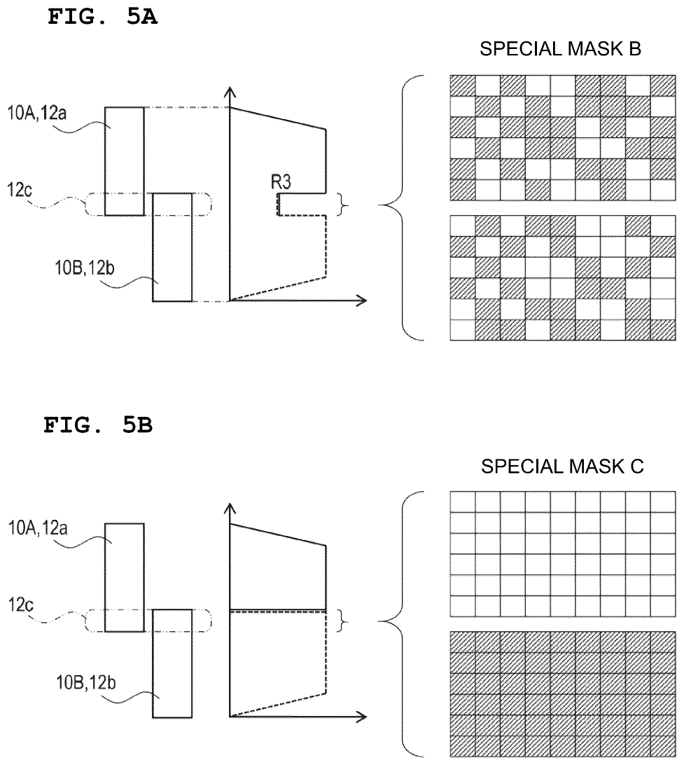

Furthermore, the right portion of FIG. 4A depicts a concept of the mask to be set with respect to the special color-joint area 12c, wherein a rectangle X indicates one nozzle 14, a hatched rectangle X1 indicates a nozzle 14 of which use is permitted, and an outlined rectangle X2 indicates a nozzle 14 of which use is not permitted. Moreover, in this conceptual view, the upper diagram is a first mask with respect to the nozzles 14 located in the special color-joint area 12c in the first special color head 12a, and the lower diagram is a second mask with respect to the nozzles 14 located in the special color-joint area 12c in the second special color head 12b. Such first mask and second mask are combined as a set to form the mask with respect to the special color-joint area 12c. Here, an example is depicted in which nozzles 14a of which ordinal number is first to sixth counting rearward from the front end in the first special color head 12a are included in the special color-joint area 12c, and nozzles 14b of which ordinal number is first to sixth counting frontward from the rear end in the second special color head 12b are included in the special color-joint area 12c. Note that the drawing on the right portion of FIG. 4A corresponds to a part of the mask. Thus, the use-permission rate read from the drawing on the right portion of FIG. 4A may not be the same as the use-permission rate read from the graph in the center of the FIG. 4A. This annotation is also applied to FIGS. 4B and 5A.

Note that FIGS. 4B, 5A, and 5B described below are each a schematic view depicting another mask; in a similar manner as in FIG. 4A, a disposing concept is depicted on the left portion of the drawing, a graph regarding the use-permission rate is depicted in the center portion of the drawing, and a conceptual view of the mask is depicted on the right portion of the drawing.

As depicted in FIG. 4A, in the ordinary mask, the number of nozzles to be used in the ejecting of the liquid (that is, the number of nozzles of which use is permitted), among the first nozzles 14a located in the special color-joint area 12c and aligned in the left-right direction, increases rearward at a predetermined ratio R1. In other words, in the case of the plurality of first nozzles 14a located in the special color-joint area 12c, the use-permission rate with respect to one nozzle row 17 increases at the predetermined ratio R1 further at a nozzle row 17 located farther rearward.

The number of nozzles to be used in the ejecting of the liquid (that is, the number of nozzles of which use is permitted), among the second nozzles 14b located in the special color-joint area 12c and aligned in the left-right direction, decreases rearward at a predetermined ratio R1. In other words, in the case of the plurality of second nozzles 14b located in the special color-joint area 12c, the use-permission rate with respect to one nozzle row 17 decreases at the predetermined ratio R1 further at a nozzle row 17 located farther rearward.

As described above, the ratio R1 at which the use-permission rate increases in the first mask corresponding to the first nozzles 14a and the ratio R1 at which the use-permission rate decreases in the second mask corresponding to the second nozzles 14b are set to be the same. Further, the use-permission rate of the first nozzles 14a and the use-permission rate of the second nozzles 14b are set such that the use-permission rates of the nozzle 14 is 100% regarding each of the positions in the front-rear direction, in a case where the first mask and the second mask are superimposed. The minimum value V1 of the use-permission rate R1 (a value at the front end of the graph in the solid line and a value at the rear end of the graph in the dashed line) is zero.

The occurrence of the above-described banding can be reduced by using such a mask. On the other hand, in a case where such a mask is used, the use frequency of a part of the nozzles 14 becomes low. Accordingly, the ink inside such a part of the nozzles is likely to dry. For example, in the case of the ordinary mask depicted in FIG. 4A, the ink inside a nozzle 14a located closer to the front end in the first special color head 12a is more likely to dry, and the ink inside a nozzle 14b located closer to the rear end in the second special color head 12b is more likely to dry. Further, in the printing process, generally, the use frequency of the special color ink tends to be inherently lower than the use frequency of the process color ink. Therefore, the ink inside the nozzles 14, in the special color head 12, with respect to which the mask is set is particularly likely to dry.

In view of the above-described situation, the liquid ejecting apparatus 1 according to the present embodiment is configured to include a plurality of masks with different powers regarding recovery power for recovering the drying of the ink in the nozzles 14 (that is, the liquid ejecting apparatus 1 is configured to store the plurality of masks in the memory 42), and to select and use one mask from the plurality of masks according to drying risk.

The above-described “permission” of the use of the nozzles will be additionally described. For example, in a case where one ejection head 10 has two hundreds and ten nozzles 14, an identification number is set to each of the nozzles 14 and the set identification numbers are stored, for example, in the memory 42. Further, a flag indicating that the nozzle 14 is permitted to be used (hereinafter referred to as “use permission flag” in some cases) or a flag indicating that the nozzle 14 is not permitted to be used (hereinafter referred to as “unusable flag” in some cases) is set with respect to each of the identification numbers, and the relationship between the identification numbers and the set flags is managed with table data. For example, in a case where the flags are expressed by two types of numbers which are “0” and “1”; the use permission flag is expressed by “0” and the unusable flag is expressed by “1”. Furthermore, the use of a certain nozzle is “permitted” means that, among the nozzles having the identification numbers to which the use permission flag is set, a drive signal is input only to the driving elements 16 corresponding to a part or all of the nozzles selected according to the print image, or that a drive signal is not input to the driving elements 16 corresponding to the nozzles having the identification numbers to which the unusable flag is set.

### (Special Mask A)

FIG. 4B is a schematic view for describing another mask (special mask A). In a first mask of the special mask A, the number of nozzles to be used in the ejecting of the liquid (that is, the number of nozzles of which use is permitted), among the first nozzles 14a located in the special color-joint area 12c and arranged in the left-right direction, increases rearward at a predetermined ratio R2. In other words, in the case of the plurality of second nozzles 14a located in the special color-joint area 12c, the use-permission rate with respect to one nozzle row 17 increases at the ratio R2 further at a nozzle row 17 located farther rearward.

Further, in the second mask of the special mask A, the number of nozzles to be used in the ejecting of the liquid (that is, the number of nozzles of which use is permitted), among the second nozzles 14b located in the special color-joint area 12c and arranged in the left-right direction, decreases rearward at a predetermined ratio R2. In other words, in the case of the plurality of second nozzles 14b located in the special color-joint area 12c, the use-permission rate with respect to one nozzle row 17 decreases at the ratio R2 further at a nozzle row 17 located farther rearward.

Note that the ratio R2 in the special mask A is smaller than the ratio R1 in the ordinary mask (0<R2<R1). Therefore, as appreciated from a comparison between the ordinary mask in FIG. 4A and the special mask A in FIG. 4B, the use-permission rate changes significantly in the front-rear direction in the ordinary mask, whereas the aspect of the change in the use-permission rate in the special mask A is smaller than the aspect of the change in the use-permission rate in the ordinary mask. Further, the use-permission rate of the first nozzles 14a and the use-permission rate of the second nozzles 14b are set such that the use-permission rates of the nozzle 14 is 100% regarding each of the positions in the front-rear direction, in a case where the first mask and the second mask are superimposed. The minimum value V2 of the use-permission rate R2 (a value at the front end of the graph in the solid line and a value at the rear end of the graph in the dashed line) is greater than zero. That is, the minimum value V2 of the use-permission rate R2 is greater than the minimum value V1 of the use-permission rate R1.

In such a special mask A, the use-permission rate of nozzles 14a located closely to the front end of the first special color head 12a and the use-permission rate of nozzles 14b located closely to the rear end of the second special color head 12b are higher compared to the case in the ordinary mask. Therefore, by using the special mask A as the mask to be used in the special color-joint area 12c, rather than using the ordinary mask, the drying of the ink in each of the nozzles 14a and 14b can be recovered.

### (Special Mask B)

FIG. 5A is a schematic view for describing another mask (special mask B). In a first mask of the special mask B, the number of nozzles to be used in the ejecting of the liquid (that is, the number of nozzles of which use is permitted), among the first nozzles 14a located in the special color-joint area 12c and aligned in the left-right direction, is constant in the front-rear direction. To be more precise, in the example of FIG. 5A, the ratio R3 is 0 (zero) (R3=0), and the use-permission rate has a constant value (50%) regardless of the positions of the first nozzles 14a.

Further, in a second mask of the special mask B, the number of nozzles to be used in the ejecting of the liquid (that is, the number of nozzles of which use is permitted), among the second nozzles 14b located in the special color-joint area 12c and aligned in the left-right direction, is constant in the front-rear direction. To be more precise, in the example of FIG. 5A, the ratio R3 is 0 (zero) (R3=0), and the use-permission rate has a constant value (50%) regardless of the positions of the first nozzles 14a.

As described above, the ratio R3 in the special mask B is further smaller than the ratio R2 in the special mask A (R3<R2). Therefore, as appreciated from the comparison between the special mask A in FIG. 4B and the special mask B in FIG. 5A, the use-permission rate changes in the front-rear direction in the special mask A, whereas the aspect of the change in the use-permission rate in the special mask B is further smaller than the aspect of the change in the use-permission rate in the special mask A, and does not change substantially. Note that, also regarding the special mask B, the use-permission rate of the first nozzles 14a and the use-permission rate of the second nozzles 14b are set such that the use-permission rates of the nozzle 14 is 100% regarding each of the positions in the front-rear direction, in a case where the first mask and the second mask are superimposed. The minimum value V3 of the use-permission rate R3 (a value at the front end of the graph in the solid line and a value at the rear end of the graph in the dashed line) is greater than zero. That is, the minimum value V3 of the use-permission rate R3 is greater than the minimum values V1, V2 of the use-permission rates R1, R2.

In such a special mask B, the use-permission rate of nozzles 14a located closely to the front end of the first special color head 12a and the use-permission rate of nozzles 14b located closely to the rear end of the second special color head 12b are further higher compared to the case in the special mask A. Therefore, by using the special mask B as the mask to be used in the special color-joint area 12c, rather than using the ordinary mask or the special mask A, the drying of the ink in each of the nozzles 14a and 14b can be recovered further strongly.

The ordinary mask, the special mask A, and the special mask B described above are mutually different in the banding-reducing effect (banding-resistant extent) and in the liquid dryness-recovering effect (dryness-resistant extent), according to the differences in the aspect of change in the use-permission rate of the nozzles 14. Specifically, the banding-resistant extent decreases in the order of the ordinary mask, the special mask A, and the special mask B. On the other hand, the dryness-resistant extent increases in the order of the ordinary mask, the special mask A, and the special mask B. Further, the minimum value of the use-permission rate increased in the order of the ordinary mask, the special mask A, and the special mask B. In other words, the minimum value of the use-permission rate is different from each other among the plurality of masks. Accordingly, the liquid ejecting apparatus 1 selects any one of the ordinary mask, the special mask A, and the special mask B depending on the drying risk.

### (Special Mask C)

The liquid ejecting apparatus 1 has yet another mask (special mask C) which is to be selected from a viewpoint different from the drying risk. The special mask C will be described below. FIG. 5B is a schematic view for describing the special mask C. In a first mask of the special mask C, the use is not permitted with respect to all nozzles 14a corresponding to the first mask, and in a second mask of the special mask C, the use is permitted with respect to all nozzles 14b corresponding to the second mask. In other words, this special mask C is a mask which uses only the nozzles 14b of the second special color head 12b with respect to the special color-joint area 12c, without using the nozzle 14a of the first special color head 12a.

Such a special mask C is selected in a case where non-ejection occurs in the first nozzles 14a in the special color-joint area 12c. Note that, as the special mask C, a mask which uses only the nozzles 14a of the first special color head 12a with respect to the special color-joint area 12c, without using the nozzles 14b of the second special color head 12b, contrary to the example indicated in FIG. 5B, is also stored in the memory 42. Such a special mask C is selected in a case where the non-ejection occurs in the second nozzles 14b in the special color-joint area 12c.

### (Printing Process)

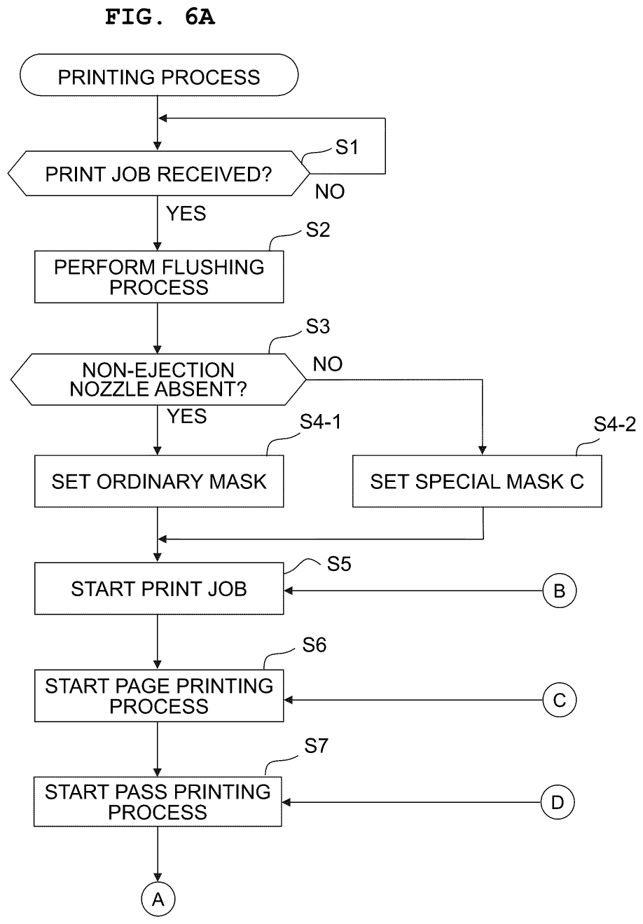

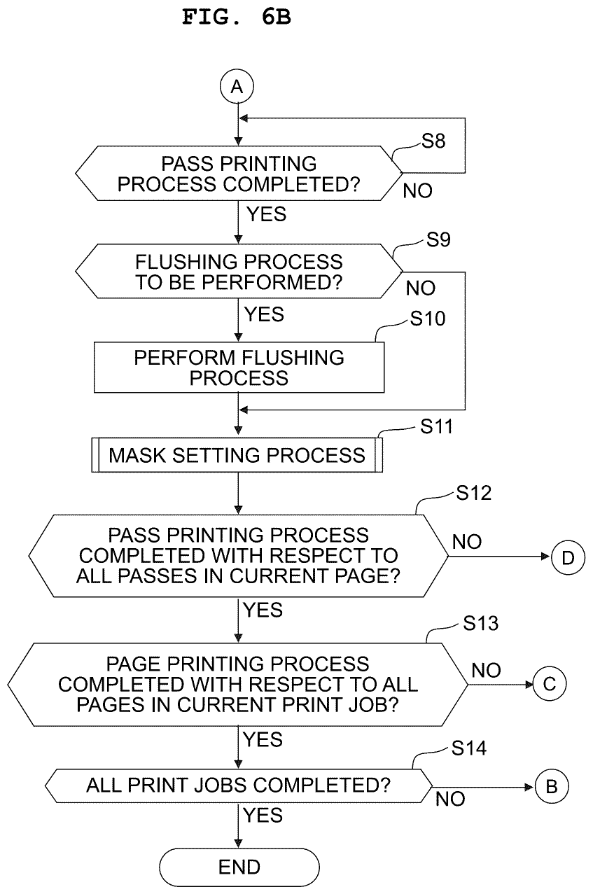

Next, the printing process by the liquid ejecting apparatus 1 described above will be described. FIGS. 6A and 6B are flow charts indicating an example of an operation of the liquid ejecting apparatus 1 in the printing process. The liquid ejecting apparatus 1 substantially starts the printing process by receiving the print job (although the liquid ejecting apparatus 1 is described as executing the steps indicated in the flow charts of FIGS. 6A and 6B in the following, specifically for example, the controller 40 may execute the steps indicated in the flow charts of FIGS. 6A and 6B). The printing process is a process of performing printing by using a selected one mask based on the print job, and is started by the liquid ejecting apparatus 1 in a case where the liquid ejecting apparatus 1 receives the print job. That is, the liquid ejecting apparatus 1 determines whether the print job has been received (step S1). In a case where the liquid ejecting apparatus 1 determines that the print job has not been received (step S1: NO), the liquid ejecting apparatus 1 repeats the operation of the step S1; in a case where the liquid ejecting apparatus 1 determines that the print job has been received (step S1: YES), the liquid ejecting apparatus 1 proceeds to the next step and performs a flushing process (step S2).

In the flushing process (step S2), the liquid ejecting apparatus 1 causes the carriage 27 to move to a maintenance area outside the platen 20 and the plurality of ejection heads 10 to discharge liquid from the nozzles 14 (the first nozzles 14a and the second nozzles 14b) of each of the ejection heads 10 at the maintenance area. This changes the liquid in the nozzles 14 of each of the ejection heads 10 from a drying state to a refreshed state.

Next, the liquid ejecting apparatus 1 determines the presence or absence of a non-ejection nozzle (step S3). More specifically, the liquid ejecting apparatus 1 executes a non-ejection detecting process of detecting whether the non-ejection nozzle is present in the part of the first nozzles 14a or the part of the second nozzles 14b, each being included in the joint area.

In a case where the liquid ejecting apparatus 1 determines, as a result of the determination of the presence or absence of the non-ejection nozzle, that the non-ejection nozzle is absent (step S3: YES), the controller 40 sets the use of the ordinary mask with respect to the joint area as an example of a mask selecting process (step S4-1). The ordinary mask is exemplified by a mask having the configuration as depicted in FIG. 4A. Note that, such a configuration may also be adopted wherein the use of the ordinary mask may be set as the initial setting in the printing process, rather than setting the use of the ordinary mask in the case where the non-ejection nozzle is absent, and wherein the setting of the mask is performed only in a case where a mask other than the ordinary mask is to be used.

On the other hand, in a case where the liquid ejecting apparatus 1 determines that the non-ejection nozzle is present (step S3: NO) as the result of the determination of the presence or absence of the non-ejection nozzle, the controller 40 sets the use of the special mask C with respect to the joint area, as an example of the mask selecting process (step S4-2). For example, in a case where the liquid ejecting apparatus 1 determines, with respect to the two special color heads 12a and 12b, that a part of the first nozzles 14 or all of the first nozzles 14a are the non-ejection nozzles in the special color-joint area 12c, the controller 40 selects, with respect to the special color-joint area 12c, the special mask C which does not use any of the first nozzles 14a located in the special color-joint area 12c, and uses only the second nozzles 14b located in the special color-joint area 12c before executing a page printing process (Step 6). Such a special mask C is exemplified by a mask having the configuration as depicted in FIG. 5B. Note that such a selection and setting of the ordinary mask or the special mask C is performed before the start of the print job (step S5). That is, for example, in a case where the switching from the ordinary mask to the special mask C is performed during the printing of an image, the image quality might deteriorate unexpectedly. On the other hand, by performing the switching before the start of the print job, such deterioration in the image quality can be avoided.

The determination of the presence or absence of the non-ejection nozzle is not limited to specific method, and may be performed using any known determining method. For example, a method may be used wherein a light-emitting element and a light-receiving element are disposed so that a flying route of the liquid ejected from the nozzle 14 is interposed between the light-emitting element and the light-receiving element; the light is emitted; and the presence or absence of the ejection of the liquid is determined based on the change in the amount of the light received in a case where the driving element 16 is driven. Alternatively, a method may be used wherein a predetermined voltage is applied between the ejection head 10 and a facing electrode disposed below the ejection head 10, and the presence or absence of the ejection of the liquid is determined based on the change in the volage in a case where the driving element 16 is driven so as to eject the liquid (electrically charged liquid) from the nozzle 14. Note that such a determination of the presence or absence of the non-ejection nozzle (step S3) may be performed simultaneously with the flushing process (step S2).

In a case where the ordinary mask is set in the step S4-1, or in a case where the special mask C is set in the step S4-2, the liquid ejecting apparatus 1 starts the print job (step S5). In other words, the liquid ejecting apparatus 1 performs the printing based on the print job and by using the one mask selected in the step S4-1 or the step S4-2. For example, the liquid ejecting apparatus 1 starts the page printing process (step S6) in the case where the liquid ejecting apparatus 1 starts the print job, and then starts the pass printing process (step S7). Here, the term “page printing process” (step S6) is a process of managing the printing operation with respect to each page in a case where the print job has a content to print an image of one page or images of a plurality of pages. Further, the pass printing process (step S7) is a process of managing the printing operation with respect to each pass in a case where an image to be printed in one page has content composed of one pass or a plurality of passes, and selected one mask is used in the printing operation. Therefore, in the print job, the printing is executed per one pass unit, which is the smallest unit, and in a case where the printing is completed with respect to all the passes included in one page, the printing is executed also per one pass with respect to the next page. In a case where the printing is completed with respect to all the pages, the print job is ended.

After the liquid ejecting apparatus 1 has started the pass printing (step S7), the liquid ejecting apparatus 1 determines whether the pass printing has been completed (step S8). In a case where the liquid ejecting apparatus 1 determines that pass printing has not been completed (step S8: NO), the liquid ejecting apparatus 1 repeats the process of the step S8. On the other hand, in a case where the liquid ejecting apparatus 1 determines that the pass printing has been completed (step S8: YES), the liquid ejecting apparatus 1 determines whether the flushing process is to be performed (step S9). In the step S9, the liquid ejecting apparatus 1 determines that the flushing process is to be performed in a case where a predetermined condition is satisfied. The predetermined condition is exemplified by a state that the drying extent of the liquid in the nozzle 14 has reached a predetermined extent or more. For example, a state that a predetermined period or more has elapsed since the flushing process having been performed last time (hereinafter referred to as “last flushing process” in some cases) may be set as the predetermined condition.

The liquid ejecting apparatus 1 performs the flushing process (step S10) in a case where the liquid ejecting apparatus 1 determines in the step S9 that the flushing process is to be performed (step S9: YES). In a case where the liquid ejecting apparatus 1 has determined that the flushing process is not to be performed (step S9: NO), or in a case where the liquid ejecting apparatus 1 has performed the flushing process in the step S10, the liquid ejecting apparatus 1 performs a mask setting process (step S11). The mask setting process (step S11) will be described later.

After the liquid ejecting apparatus 1 has set the mask to be used with respect to the joint area by the mask setting process in the step S11, the liquid ejecting apparatus 1 then determines whether the pass printing process has been completed with respect to all the passes in the current page (step S12). In a case where the liquid ejecting apparatus 1 determines that the pass printing process has not been completed with respect to all the passes (step S12: NO), the liquid ejecting apparatus 1 returns the procedure to the step S7 and starts the pass printing process with respect to the next pass. On the other hand, in a case where the liquid ejecting apparatus 1 determines that the pass printing process has been completed with respect to all the passes (step S12: YES), the liquid ejecting apparatus 1 determines whether the page printing process has been completed with respect to all the pages in the current print job (step S13). In a case where the liquid ejecting apparatus 1 determines that the page printing process has not been completed with respect to all the pages (step S13: NO), the liquid ejecting apparatus 1 returns the procedure to the step S6 and starts the page printing process with respect to the next page.

In a case where the liquid ejecting apparatus 1 determines that the pass printing process has been completed with respect to all the pages (step S13: YES), the liquid ejecting apparatus 1 determines whether all the received print jobs have been completed (step S14). For example, in a case where the liquid ejecting apparatus 1 has received another print job while executing one print job, a non-executed print job is present. In this case, the liquid ejecting apparatus 1 determines in the step S14 that all the print jobs have not been completed (step S14: NO), and performs the processes from the step S5 so as to execute the next print job. On the other hand, in a case where the liquid ejecting apparatus 1 determines that the non-executed print job as described above is not present (step S14: YES), the liquid ejecting apparatus 1 ends the printing process in FIGS. 6A and 6B.

### (Mask Setting Process)

The mask setting process performed in the step S11 will be described in detail. The mask setting process includes a risk obtaining process and a mask selecting process. The risk obtaining process is a process of obtaining information regarding the drying risk of the liquid in each nozzle of the first nozzles 14a and the second nozzles 14b included in the joint area. As the drying risk, for example, an elapsed time since the last flushing process can be used. Further, the mask selecting process is a process of selecting, according to the drying risk, one mask, among the plurality of masks having mutually different ratios at which the use-permission rate changes.

Note that, as described above, the mask defines the ratio at which the use-permission rate with respect to one nozzle row 17 of the first nozzles 14a included in the joint area increases rearward, and the ratio at which the use-permission rate with respect to the one nozzle row 17 of the second nozzles 14b included in the joint area decreases rearward. A plurality of kinds of masks including, for example, the ordinary mask (ratio: R1) in FIG. 4A, the special mask A (ratio: R2) in FIG. 4B, and the special mask B (ratio: R3) in FIG. 5A, are prepared in advance and stored in memory 42.

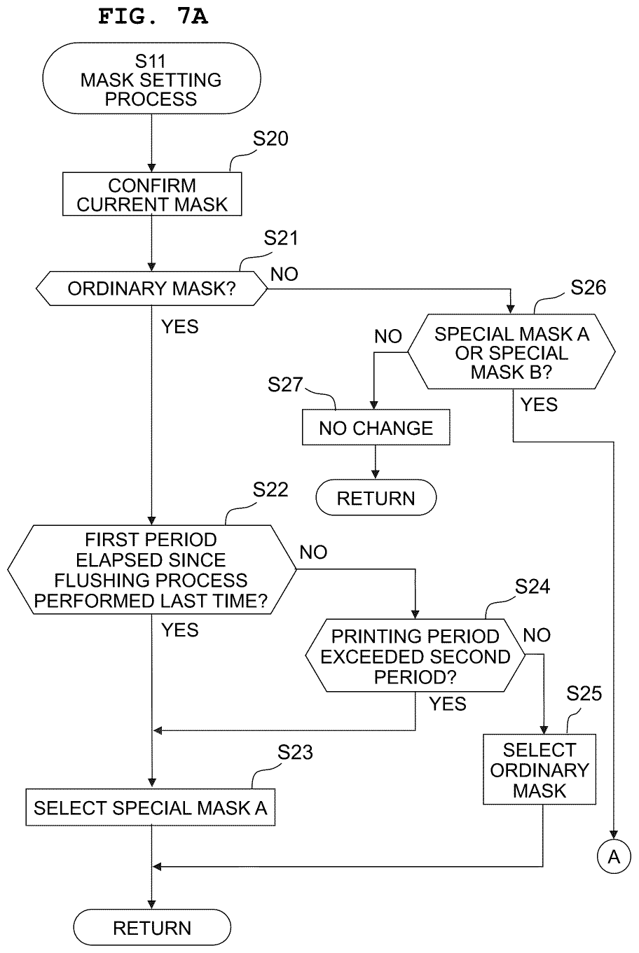

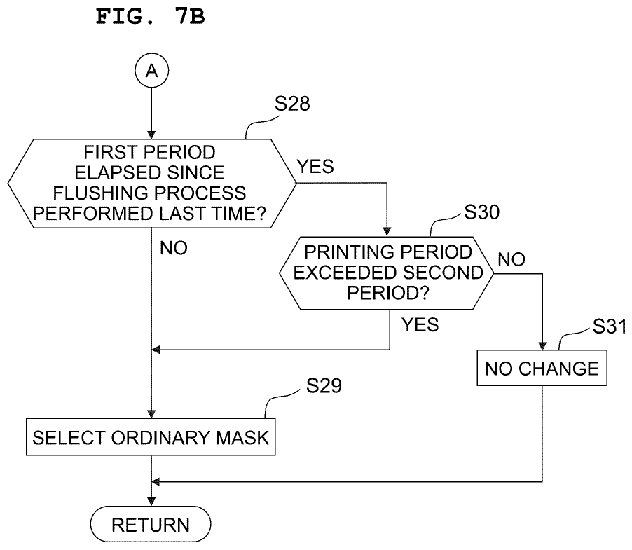

FIGS. 7A and 7B are flow charts indicating an example of the mask setting process and corresponding to the content of a subroutine of the step S11 in the flow charts of FIGS. 6A and 6B (although the liquid ejecting apparatus 1 is described as executing the steps indicated in the flow charts of FIGS. 7A and 7B in the following, specifically for example, the controller 40 executes the steps indicated in the flow charts of FIGS. 7A and 7B). As indicated in FIG. 7, in the mask setting process, the liquid ejecting apparatus 1 first confirms the kind of a current mask (step S20). Then, the liquid ejecting apparatus 1 determines whether the current mask is the ordinary mask (step S21). In a case where the liquid ejecting apparatus 1 determines that the current mask is the ordinary mask (step S21: YES), the liquid ejecting apparatus 1 determines whether a first period has elapsed since the last flushing process (step S22). In other words, in the step S22, the liquid ejecting apparatus 1 obtains the elapsed time since the last flushing process, as an example of the risk obtaining process, and also determines whether the obtained elapsed time has exceeded the first period.

In a case where the liquid ejecting apparatus 1 determines in the step S22 that the first period has elapsed since the last flushing process (step S22: YES), the liquid ejecting apparatus 1 selects the special mask A (step S23). That is, in a case where the first period has elapsed since the last flushing process, the liquid ejecting apparatus 1 may determine that the liquid in the nozzles 14 is dried to some extent and that the drying risk is high. Therefore, the liquid ejecting apparatus 1 selects a mask from the current ordinary mask (ratio: R1) to the special mask A (ratio: R2; R2<R1) of which dryness-resistant extent is one extent higher than the dryness-resistant extent of the ordinary mask.

In a case where the liquid ejecting apparatus 1 determines in the step S22 that the first period has not elapsed since the last flushing process (step S22: NO), the liquid ejecting apparatus 1 further determines whether the printing period has exceeded a second period (step S24). That is, in the step S24, the liquid ejecting apparatus 1 obtains the printing period with the ordinary mask as an example of the risk obtaining process, and determines whether the obtained printing period has exceeded the second period.

In a case where the liquid ejecting apparatus 1 determines in the step S24 that the obtained printing period has exceeded the second period (step S24: YES), the liquid ejecting apparatus 1 selects the special mask A (step S23). That is, even in a case where the first period has not elapsed since last flushing process (step S22: NO), in a case where the printing period with the ordinary mask of which the dryness-resistant extent is low has exceeded the second period (step S24: YES), the liquid ejecting apparatus 1 may determine that the liquid in the nozzles 14 is dried to some extent and that the drying risk is high. Therefore, the liquid ejecting apparatus 1 selects to perform the switching from the current ordinary mask (ratio: R1) to the special mask A (ratio: R2; R2<R1) of which the dryness-resistant extent is one extent higher than the dryness-resistant extent of the ordinary mask.

In a case where the liquid ejecting apparatus 1 determines in the step S24 that the obtained printing period has not exceeded the second period (step S24: NO), the liquid ejecting apparatus 1 selects the ordinary mask (step S25). That is, in a case where the first period has not elapsed since the last flushing process (step S22: NO) and that the printing period with the ordinary mask has not exceeded the second period (step S24: NO), the liquid ejecting apparatus 1 may determine that the drying of the liquid in the nozzles 14 has not advanced much and that the drying risk is low. Therefore, the liquid ejecting apparatus 1 selects to maintain the ordinary mask currently used and takes the countermeasure against the banding.

On the other hand, in a case where the liquid ejecting apparatus 1 determines in the step S21 that the current mask is not the ordinary mask (step S21: NO), the liquid ejecting apparatus 1 then determines whether the current mask is the special mask A or the special mask B (step S26). In a case where the liquid ejecting apparatus 1 determines that the current mask is neither the special mask A nor the special mask B (step S26: NO), then this means that the current mask is the special mask C used in a case where the non-ejection nozzle is present. Therefore, in this case, the liquid ejecting apparatus 1 selects not to change the mask from the special mask C (step S27).

In a case where the liquid ejecting apparatus 1 determines in the step S26 that the current mask is the special mask A or the special mask B (step S26: YES), the liquid ejecting apparatus 1 determines whether the first period has elapsed since the last flushing process (step S28). That is, in the step S28, the liquid ejecting apparatus 1 obtains the elapsed time since the last flushing process, as an example of the risk obtaining process, and determines whether the obtained elapsed time has exceeded the first period.

The liquid ejecting apparatus 1 selects the ordinary mask (step S29) in a case where the liquid ejecting apparatus 1 determines in the step S28 that the obtained elapsed time since the last flushing process has not exceeded the first period (step S28: NO). That is, in a case where the liquid ejecting apparatus 1 determines that the first period has not elapsed since the last flushing process, the liquid ejecting apparatus 1 may determine that the drying of the liquid in the nozzles 14 has not advanced much and that the drying risk is low. Therefore, the liquid ejecting apparatus 1 selects to perform the switching from the current special mask A or special mask B to the ordinary mask of which the dryness-resistant extent is lower but the banding-resistant extent is higher as compared with the special mask A or B.

In a case where the liquid ejecting apparatus 1 determines in the step S28 that the first period has elapsed since the last flushing process (step S28: YES), the liquid ejecting apparatus 1 further determines whether the printing period has exceeded the second period (step S30). That is, in the step S30, the liquid ejecting apparatus 1 obtains the printing period with the special mask A or the special mask B as an example of the risk obtaining process, and also determines whether the obtained printing period has exceeded the second period.

In a case where the liquid ejecting apparatus 1 determines in the step S30 that the printing period with the special mask A or B has exceeded the second period (step S30: YES), the liquid ejecting apparatus 1 selects the ordinary mask (step S29). That is, even in a case where the first period has elapsed since the last flushing process (step S28: YES), in a case where the printing period with the special mask A or the special mask B of which the dryness-resistant extent is high has exceeded the second period (step S30: YES), the liquid ejecting apparatus 1 may determine that the drying of the liquid in the nozzles 14 has not advanced much and that the drying risk is low. Therefore, the liquid ejecting apparatus 1 selects to perform switching from the current special mask A or special mask B to the ordinary mask of which the dryness-resistant extent is lower but the banding-resistant extent is higher as compared with the special mask A or B.

In a case where the liquid ejecting apparatus 1 determines in the step S30 that the printing period with the special mask A or B has not exceeded the second period (step S30: NO), the liquid ejecting apparatus 1 selects not to change the current mask (step S31). That is, in a case where the liquid ejecting apparatus 1 determines that the first period has elapsed since the last flushing process (step S28: YES) and that the printing period with the special mask A or the special mask B has not exceeded the second period (step S30: NO), the liquid ejecting apparatus 1 may determine that the recovery from the drying of the liquid in the nozzles 14 has not advanced much and that the drying risk is high. Therefore, the liquid ejecting apparatus 1 selects to maintain the special mask A or the special mask B currently used and takes the countermeasure against the dryness.

The process in each of the steps S23, S25, S27, S29 and S31 corresponds to the mask selecting process of selecting one mask depending on the drying risk. In a case where the mask selecting process is completed, the subroutine related to the mask setting process in the step S11 is ended. Therefore, the liquid ejecting apparatus 1 then proceeds the procedure to the process in the step S12 of the flow chart of FIG. 6B.

The mask setting process, including the mask selecting process as described above, is performed before or after the start of the pass printing process with respect to one pass during the execution of the print job. For example, as depicted in FIGS. 6A and 6B, the mask setting process (step S11) is performed after the end of the pass printing process which has been executed last time or before the start of the pass printing process to be executed next. In this manner, the mask is not switched while the pass printing process is being executed so as to avoid the deterioration in the image quality which would be otherwise caused due to the switching of masks.

Further, the mask selecting process in FIGS. 7A and 7B (in particular, the process in the step S23) is executed so that the higher the drying risk is, the mask with the smaller ratio regarding the change in the use-permission rate (that is, the mask of which the minimum value of the use-permission rate is greater) is selected. With this, as the drying risk is higher, the use frequency of the nozzles 14 with low use frequency can be increased further so that the drying of the ink in the nozzles 14 can be recovered. Note that the “first period” in the step S22 and the “first period” in the step S28 may be periods having mutually different lengths, and the “second period” in the step S24 and the “second period” in the step S30 may also be periods having mutually different lengths. Furthermore, the length of the first period in the step S28 or the length of the second period in the step S30 may be different between the case where the current mask is the special mask A and the case where the current mask is the special mask B.

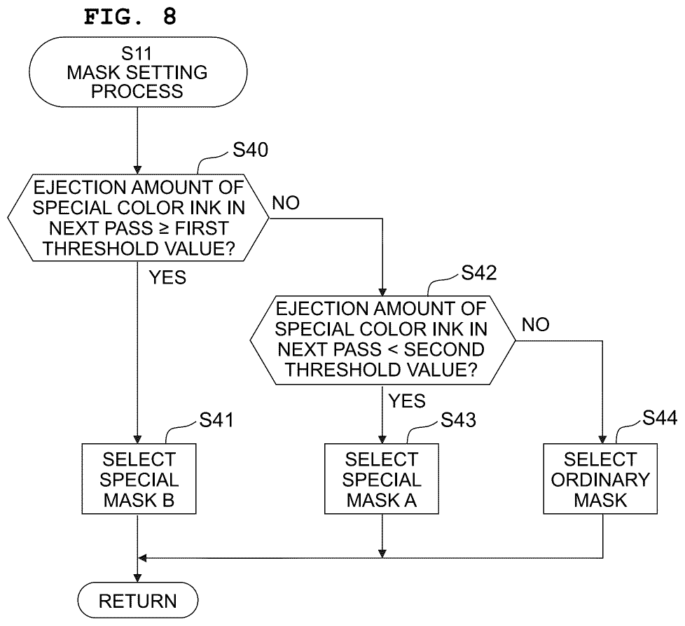

FIG. 8 is a flow chart indicating another example of the mask setting process, and corresponds to the content of the subroutine of the step S11 in the flow chart of FIG. 6B (although the liquid ejecting apparatus 1 is described as executing the steps indicated in the flow chart of FIG. 8 in the following, specifically for example, the controller 40 executes the steps indicated in the flow chart of FIG. 8). Although the mask setting process focusing on the countermeasure against the drying of the special color ink is described here, a similar process is also applicable as the countermeasure against the drying of the liquid of the kind other than the special color ink (the color ink or white background ink).

The mask setting process indicated in FIG. 8 includes a risk obtaining process of obtaining an ejection amount of the special color ink in the next pass as information regarding the drying risk, and a mask selecting process of selecting the mask based on the obtained ejection amount of the special color ink. The ejection amount of the special color ink can be obtained from the information included in the print job received by the liquid ejecting apparatus 1. Further, in the mask selecting process, in a case where the ejection amount of the special color ink in the next pass is a predetermined first threshold value or more, the liquid ejecting apparatus 1 selects the mask in which the ratio regarding the change in use-permission rate is smaller compared to a case where the ejection amount of the special color ink in the next pass is less than the first threshold value. In other words, the liquid ejecting apparatus 1 selects the mask with the minimum value V2 of the use-permission rate R2 being greater, compared to a case where the ejection amount of the special color ink in the next pass is less than the first threshold value, the minimum value V2 being greater than the minimum value V1 of the use-permission rate R1. Furthermore, in the mask selecting process, in a case where the ejection amount of the special color ink in the next pass is less than a predetermined second threshold value which is smaller than the first threshold value, the liquid ejecting apparatus 1 selects the mask in which the ratio regarding the change in use-permission rate is smaller compared to a case where the ejection amount of the special color ink in the next pass is the second threshold value or more. In other words, the liquid ejecting apparatus 1 selects the mask with the minimum value V2 of the use-permission rate R2 being greater, compared to a case where the ejection amount of the special color ink in the next pass is less than the second threshold value, the minimum value V2 being greater than the minimum value V1 of the use-permission rate R1.

The mask setting process will be specifically described. As indicated in FIG. 8, the liquid ejecting apparatus 1 determines in the mask setting process whether the ejection amount of the special color ink in the next pass is the predetermined first threshold value or more (step S40). In a case where the liquid ejecting apparatus 1 determines that the ejection amount of the special color ink in the next pass is the first threshold value or more (step S40: YES), the liquid ejecting apparatus 1 selects the special mask B (step S41). In other words, the case wherein the ejection amount of the special color ink in the next pass is relatively great (step S40: YES) can be regarded as a chance to recover the drying of the ink in the nozzles 14 of the special color head 12. Therefore, by selecting the special mask B (ratio: R3) of which the dryness-resistant extent is the highest (step S41), the ink in the nozzles 14 can be effectively recovered from the drying in the pass printing process to be performed next.

On the other hand, in a case where the liquid ejecting apparatus 1 determines that the ejection amount of the special color ink in the next pass is less than the first threshold value (step S40: NO), the liquid ejecting apparatus 1 further determines whether the ejection amount of the special color ink in the next pass is less than the predetermined second threshold value which is smaller than the first threshold value (step S42). Further, in a case where the liquid ejecting apparatus 1 determines that the ejection amount of the special color ink in the next pass is less than the predetermined second threshold value (step S42: YES), the liquid ejecting apparatus 1 selects the special mask A (step S43). On the other hand, in a case where the liquid ejecting apparatus 1 determines that the ejection amount of the special color ink in the next pass is the second threshold value or more (step S42: NO), the liquid ejecting apparatus 1 selects the ordinary mask (step S44).

That is, in a case where the ejection amount of the special color ink in the next pass is relatively small (step S42: YES), the drying of the ink in the nozzles 14 of the special color head 12 might advance due to the next pass printing process. Therefore, by selecting the special mask A, in which the dryness-resistant extent is relatively high (step S43), the drying of the ink in the next pass printing process can be avoided. Further, in a case where the ejection amount of the special color ink in the next pass is neither particularly great nor particularly small (step S42: NO), the countermeasure against the banding can be achieved by selecting the ordinary mask (step S44).

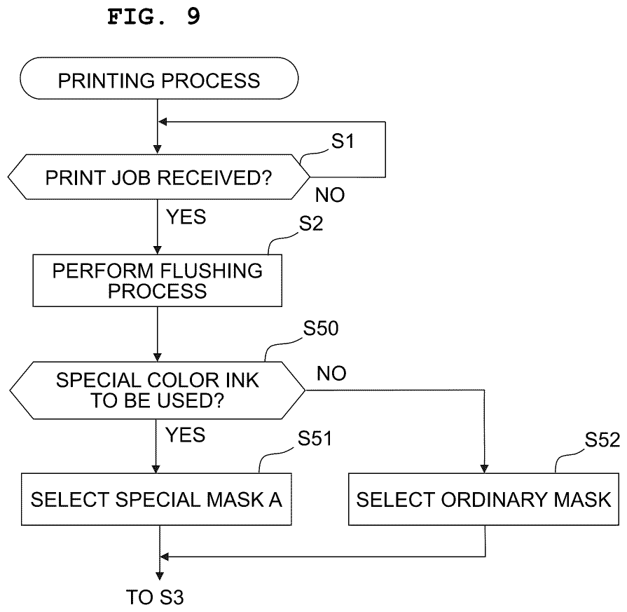

FIG. 9 is a flow chart indicating another example of the mask setting process, and indicates three processes (step S50, step S51 and step S52) added between the step S2 and the step S3 in the flow chart of FIG. 6A (although the liquid ejecting apparatus 1 is described as executing the steps indicated in the flow chart of FIG. 9 in the following, specifically for example, the controller 40 executes the steps indicated in the flow chart of FIG. 9). In the example of FIG. 9, in a case where the printing process in the special color-joint area 12c is included in the print job, in the mask selecting process, the mask in which the ratio regarding the change in the use-permission rate is smaller is selected, compared to a case where the printing process in the special color-joint area 12c is not included in the print job. In other words, in a case where the printing process in the special color-joint area 12c is included in the print job, the liquid ejecting apparatus 1 selects the mask with the minimum value V2 of the use-permission rate R2 being greater, compared to a case where the printing process in the special color-joint area 12c is not included in the print job, the minimum value V2 being greater than the minimum value V1 of the use-permission rate R1.

The mask selecting process will be specifically described. In the case indicated in FIG. 9, after executing the flushing process (step S2), the liquid ejecting apparatus 1 determines whether the special color ink is to be used in the print job to be executed, based on the content of the print job (step S50). Since the use frequency of the special color ink is generally low, information regarding the use of the special color ink corresponds to the information regarding the drying risk. Therefore, an operation wherein the liquid ejecting apparatus 1 obtains the information as to whether the special color ink is to be used from the print job corresponds to the risk obtaining process.

Next, in a case where the liquid ejecting apparatus 1 determines in the step S50 that the special color ink is to be used in the print job to be executed (step S50: YES), the liquid ejecting apparatus 1 selects the special color mask A (ratio: R2; R2<R1) (step S51). On the other hand, in a case where the liquid ejecting apparatus 1 determines that the special color ink is not to be used in the print job to be executed (step S50: NO), the liquid ejecting apparatus 1 selects the ordinary mask (ratio: R1) (step S52). Such operations in the step S51 and the step S52 correspond to the mask selecting process of selecting the mask according to the drying risk.

By executing such an operation, the liquid ejecting apparatus 1 is capable of using the mask with the high dryness-resistant extent so as to reduce the drying of the special color ink in the print job using the special color ink. In a case where the operation indicated in FIG. 9 is adopted, the mask selected in the step S51 or the step S52 may be overwritten with a mask selected in the process of the step S3 and in the process of the step S4-1 or the step S4-2 which are subsequent to the step S51 or the step S52. Further, in a case where the operation indicated in FIG. 9 is adopted, the mask setting process in the step S11 may be omitted.

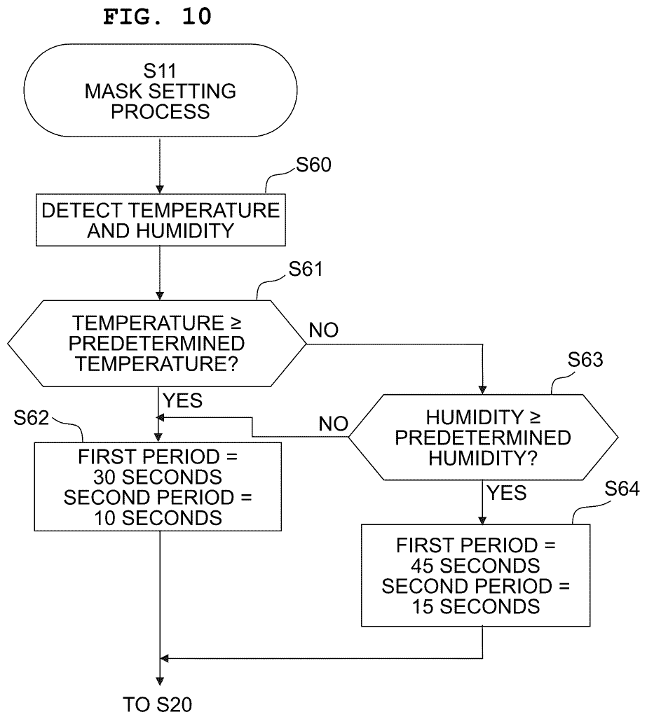

FIG. 10 is a flow chart indicating another example of the mask setting process, and corresponds to the content of the subroutine of the step S11 in the flow chart of FIG. 6B (although the liquid ejecting apparatus 1 is described as executing the steps indicated in the flow chart of FIG. 10 in the following, specifically for example, the controller 40 executes the steps indicated in the flow chart of FIG. 10). Note that the processes of the step S60 to the step S64 indicated in FIG. 10 are performed immediately after the start of the mask setting process in FIGS. 7A and 7B, i.e., before the execution of the step S20.

Further, in the example of FIG. 10, even in a case where other drying risks are the same, in a case where the temperature detected by the temperature sensor 55 is temperature of a predetermined threshold value or more, in the mask selecting process, the mask in which the ratio regarding the change in the use-permission rate is smaller is selected, compared to a case where the temperature detected by the temperature sensor 55 is less than the temperature of the predetermined threshold value. In other words, the liquid ejecting apparatus 1 selects the mask with the minimum value V2 of the use-permission rate R2 being greater, compared to a case where the temperature detected by the temperature sensor 55 is less than the temperature of the predetermined threshold value, the minimum value V2 being greater than the minimum value V1 of the use-permission rate R1. Furthermore, in the example of FIG. 10, even in a case where the other drying risks are the same, in a case where the humidity detected by the humidity sensor 56 is less than the humidity of a predetermined threshold value, in the mask selecting process, the mask in which the ratio regarding the change in the use-permission rate is smaller is selected, compared to a case where the humidity detected by the humidity sensor 56 is the humidity of the predetermined threshold value or more. In other words, the liquid ejecting apparatus 1 selects the mask with the minimum value V2 of the use-permission rate R2 being greater, compared to a case where the humidity detected by the humidity sensor 56 is the humidity of the predetermined threshold value or more, the minimum value V2 being greater than the minimum value V1 of the use-permission rate R1.

The mask selecting process will be specifically described. In the case of FIG. 10, at the beginning of the mask setting process, the liquid ejecting apparatus 1 detects the temperature and humidity (step S60). The temperature and humidity correspond to the information regarding the drying risk of the liquid in the nozzles 14. Therefore, the detection of the temperature and humidity corresponds to the risk obtaining process. Next, the liquid ejecting apparatus 1 determines whether the temperature is the temperature of the predetermined threshold value or more (step S61). In a case where the liquid ejecting apparatus 1 determines that the temperature is the temperature of the predetermined threshold value or more (step S61: YES), the liquid ejecting apparatus 1 sets the first period described with reference to FIGS. 7A and 7B to a relatively short period (e.g., 30 seconds), and also regarding the second period, the liquid ejecting apparatus 1 sets the second period to a relatively short period (e.g., 10 seconds) (step S62).

On the other hand, in a case where the liquid ejecting apparatus 1 determines in the step S61 that the temperature is less than the temperature of the predetermined threshold value (step S61: NO), the liquid ejecting apparatus 1 further determines whether the humidity is the humidity of the predetermined threshold value or more (step S63). In a case where the liquid ejecting apparatus 1 determines that the humidity is less than the humidity of the predetermined threshold value (step S63: NO), the liquid ejecting apparatus 1 executes the step S62 described above; on the other hand, in a case where the liquid ejecting apparatus 1 determines that the humidity is the humidity of the predetermined threshold value or more (step S63: YES), the liquid ejecting apparatus 1 sets the first period to a relatively long period (for example, 45 seconds), and also regarding the second period, the liquid ejecting apparatus 1 sets the second period to a relatively long period (for example, 15 seconds) (step S64).

The liquid ejecting apparatus 1 executes the above-described operation so that in a case where the temperature is relatively high and the ink is more likely to dry, the mask in which the ratio regarding the change in the use-permission rate is smaller (i.e., the mask with a higher dryness-resistant extent) is more likely to be selected compared to a case where the temperature is relatively low. In other words, in a case where the temperature is relatively high and the ink is more likely to dry, the liquid ejecting apparatus 1 is more likely to select the mask with the minimum value V2 of the use-permission rate R2 being greater, depending on the result of detection by the temperature sensor 55, the minimum value V2 being greater than the minimum value V1 of the use-permission rate R1. Similarly, the liquid ejecting apparatus 1 executes the above-described operation so that in a case where the humidity is relatively low and the ink is more likely to dry, the mask in which the ratio regarding the change in the use-permission rate is smaller (i.e., the mask with a higher dryness-resistant extent) is more likely to be selected compared to a case where the humidity is relatively high. Therefore, the liquid ejecting apparatus 1 is capable of selecting the appropriate mask based on the drying risk due to the temperature and humidity. In other words, in a case where the humidity is relatively low and the ink is more likely to dry, the liquid ejecting apparatus 1 more likely to select the mask with the minimum value V2 of the use-permission rate R2 being greater, depending on the result of detection by the humidity sensor 56, the minimum value V2 being greater than the minimum value V1 of the use-permission rate R1.

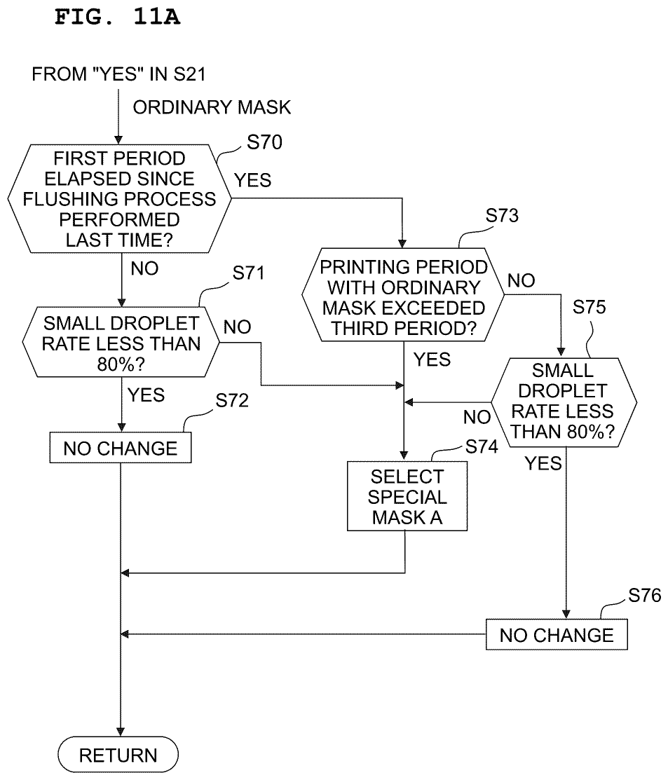

FIGS. 11A and 11B are flow charts indicating another example of the mask setting process and corresponds to the content of the subroutine of the step S11 in the flow chart of FIG. 6B (although the liquid ejecting apparatus 1 is described as executing the steps indicated in the flow charts of FIGS. 11A and 11B in the following, specifically for example, the controller 40 executes the steps indicated in the flow charts of FIGS. 11A and 11B). Note that the processes of the step S70 to the step S76 indicated in FIG. 11A replace the processes of the step S22 to the step S25 after the step S21 in FIG. 7A. Further, the processes of the step S80 to the step S86 indicated in FIG. 11B replace the processes of the step S28 to the step S31 after the step S26 in FIGS. 7A and 7B.

Further, in the example of FIG. 11A and FIG. 11B, provided that the ejection head 10 can eject a small droplet and a large droplet, in a case where the rate (small droplet rate) of an occasion where the liquid to be ejected in the joint area in the printing process is the small droplet is a predetermined threshold value or more, the mask with the ratio regarding the change in the use-permission rate which is smaller is selected, compared to a case where the small droplet rate is less than the threshold value. In other words, in a case where the rate of an occasion where the liquid to be ejected at the joint area in the printing process is the small droplet (small droplet rate), is a predetermined threshold value or more, the liquid ejecting apparatus 1 selects the mask with the minimum value V2 of the use-permission rate R2 being greater, compared to a case where the small droplet rate is less than the threshold value, the minimum value V being greater than the minimum value V1 of the use-permission rate R1. That is, the liquid in the nozzle 14 is less likely to dry and can also be easily recovered from the dried state in a case where the liquid to be ejected is the large droplet having the large volume compared to a case where the liquid to be ejected is the small droplet having the small volume. Therefore, in a case where the small droplet rate is small, the drying of the liquid is less likely to advance, and in a case where the small droplet rate is great, the drying of the liquid is more likely to advance, and thus the mask is selected depending on the drying risk as described above. Note that the volume of the liquid ejected from the nozzle 14 can be changed by adjusting the amplitude of voltage or the wavelength of voltage composed of a pulse waveform applied to the driving element 16, and the large droplet having the large volume and the small droplet having the small volume can be selectively ejected.

The example indicated in FIGS. 11A and 11B will be specifically described. Regarding FIG. 11A, in a case where the current mask is the ordinary mask (step S21: YES), the liquid ejecting apparatus 1 determines whether the first period has elapsed since the last flushing process (step S70). In a case where the liquid ejecting apparatus 1 determines that the first period has not elapsed since the last flushing process (step S70: NO), the liquid ejecting apparatus 1 determines whether the small droplet rate is less than a predetermined threshold value (e.g., 80%) (step S71). In a case where the liquid ejecting apparatus 1 determines that the small droplet rate is less than the threshold value (step S71: YES), the liquid ejecting apparatus 1 does not change the mask and maintains the use of the ordinary mask (step S72). On the other hand, in a case where the liquid ejecting apparatus 1 determines that the small droplet rate is the threshold value or more (step S71: NO), the liquid ejecting apparatus 1 selects the special mask A (step S74).

Further, in a case where the liquid ejecting apparatus 1 determines in the step S70 that the first period has elapsed since the last flushing process (step S70: YES), the liquid ejecting apparatus 1 determines whether the printing period with the current ordinary mask has exceeded a predetermined third period (step S73). In a case where the liquid ejecting apparatus 1 determines that the printing period with the current ordinary mask has exceeded the third period (step S73: YES), the liquid ejecting apparatus 1 selects the special mask A (step S74). On the other hand, in a case where the liquid ejecting apparatus 1 determines that the printing period with the current ordinary mask has not exceeded the third period (step S73: NO), the liquid ejecting apparatus 1 determines whether the small droplet rate is less than the predetermined threshold value (e.g., 80%) (step S75). In a case where the liquid ejecting apparatus 1 determines that the small droplet rate is the threshold value or more (step S75: NO), the liquid ejecting apparatus 1 selects the special mask A (step S74). On the other hand, in a case where the liquid ejecting apparatus 1 determines that the small droplet rate is less than the threshold value (step S75: YES), the liquid ejecting apparatus 1 does not change the mask and maintains the use of the ordinary mask (step S76).

Regarding the case of FIG. 11B, in a case where the current mask is the special mask A or the special mask B (step S26: YES), the liquid ejecting apparatus 1 determines whether the first period has elapsed since the last flushing process (step S80). In a case where the liquid ejecting apparatus 1 determines that the first period has not elapsed since the last flushing process (step S80: NO), the liquid ejecting apparatus 1 determines whether the small droplet rate is less than the predetermined threshold value (e.g., 80%) (step S81). In a case where the liquid ejecting apparatus 1 determines that the small droplet rate is less than the threshold value (step S81: YES), the liquid ejecting apparatus 1 changes the mask and selects the ordinary mask (step S82). On the other hand, in a case where the liquid ejecting apparatus 1 determines that the small droplet rate is the threshold value or more (step S81: NO), the liquid ejecting apparatus 1 does not change the mask and maintains the use of the special mask A or the special mask B (step S84).

Further, in a case where the liquid ejecting apparatus 1 determines in the step S80 that the first period has elapsed since the last flushing process (step S80: YES), the liquid ejecting apparatus 1 determines whether the printing period with the current special mask A or special mask B has exceeded the predetermined third period (step S83). In a case where the liquid ejecting apparatus 1 determines that the printing period with the current special mask A or special mask B has not exceeded the predetermined third period (step S83: NO), the liquid ejecting apparatus 1 does not change the mask and maintains the use of the special mask A or the special mask B (step S84). On the other hand, in a case where the liquid ejecting apparatus 1 determines that the printing period with the current special mask A or special mask B has exceeded the predetermined third period (step S83: YES), the liquid ejecting apparatus 1 determines whether the small droplet rate is less than the predetermined threshold value (e.g., 80%) (step S85). In a case where the liquid ejecting apparatus 1 determines that the small droplet rate is the threshold value or more (step S85: NO), the liquid ejecting apparatus 1 does not change the mask and maintains the use of the special mask A or the special mask B (step S84). On the other hand, in a case where the liquid ejecting apparatus 1 determines that the small droplet rate is less than the threshold value (step S85: YES), the liquid ejecting apparatus 1 changes the mask and selects the ordinary mask (step S86).

By performing the above-described operation, the liquid ejecting apparatus 1 is capable of selecting the mask suitable for the countermeasure against the dryness, depending on the small droplet rate which is an example of the drying risk.

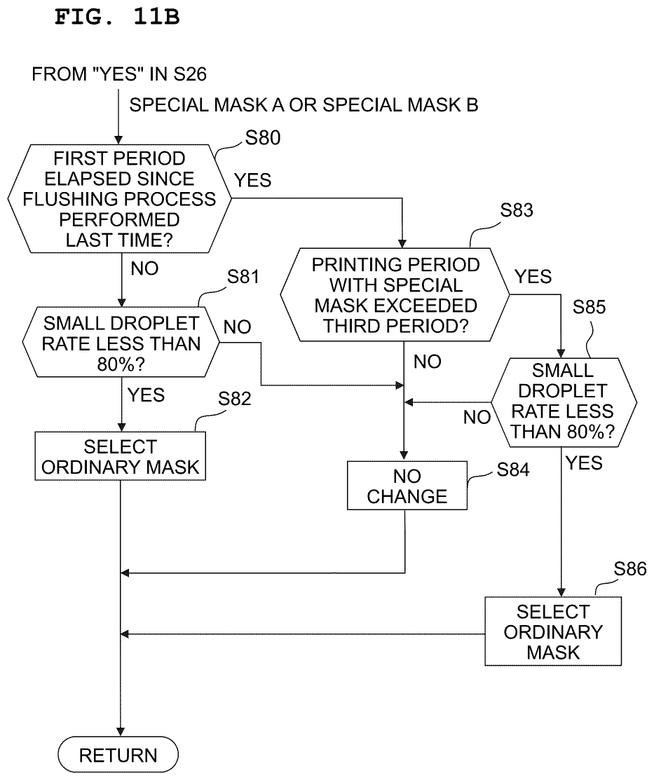

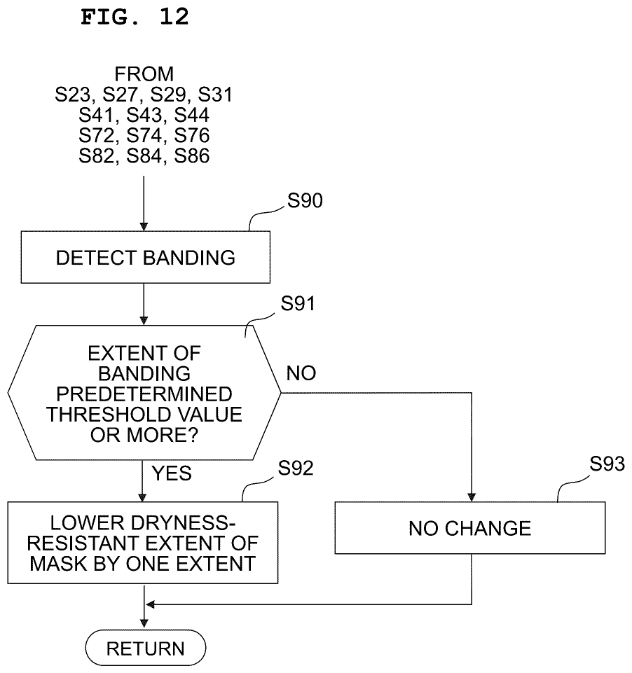

FIG. 12 is a flow chart indicating another example of the mask setting process (although the liquid ejecting apparatus 1 is described as executing the steps indicated in the flow chart of FIG. 12 in the following, specifically for example, the controller 40 executes the steps indicated in the flow chart of FIG. 12). Note that the processes of the step S90 to the step S93 indicated in FIG. 12 are the contents executed after the mask is selected in the mask setting process. The processes of the step S90 to the step S93 are such steps wherein in a case where the extent of the banding detected with respect to the joint area in the liquid ejecting apparatus 1 is great, a mask in which the ratio regarding the change in the use-permission rate is greater compared to a case where the extent of the banding detected with respect to the joint area in the liquid ejecting apparatus 1 is small is selected in the mask selecting process. The phrase “selection of a mask in the mask setting process” may be applicable, for example, to the process of each of the steps S23, S27, S29 and S31 in FIGS. 7A and 7B, the process of each of the steps S41, S43 and S44 in FIG. 8, the process of each of the steps S72, S74 and S76 in FIG. 11A, and the process of each of the steps S82, S84 and S86 in FIG. 11B.

The mask setting process indicated in FIG. 12 will be specifically described. Regarding the case of FIG. 12, once the mask is selected, the liquid ejecting apparatus 1 performs the detection of a banding with respect to the joint area (step S90). That is, the liquid ejecting apparatus 1 executes a banding detecting process so as to detect the banding in a print image caused by the deviation in the relative positions between the first ejection head 10A and the second ejection head 10B. Such a banding detecting process can be performed, for example, by capturing an image printed by the first ejection head 10A and the second ejection head 10B, with the imaging device 57 included in the liquid ejecting apparatus 1, and by analyzing data of the captured image with the controller 40.

Further, the banding detecting process also includes a process of obtaining (calculating) the extent of banding from the imaged data. The extent of banding can be determined, for example, by extracting points, from the imaged data, at which the difference in image contrast is a predetermined value or more, and based on, for example, the length in which such points are continuous. Note that the method of determining the extent of banding is not limited to this method, and other methods may be adopted.

The liquid ejecting apparatus 1 determines whether the extent of the banding detected in the step S90 is a predetermined threshold value or more (step S91). In a case where the liquid ejecting apparatus 1 determines that the extent of the banding is the threshold value or more (step S91: YES), the liquid ejecting apparatus 1 lowers the dryness-resistant extent of the mask by one extent (step S92). In other words, in a case where the liquid ejecting apparatus 1 determines that the extent of the banding is the threshold value or more (step S91: YES), the liquid ejecting apparatus 1 selects the ordinary mask with the minimum value V1 of the use-permission rate R1 being smaller and the ratio regarding the change in use-permission rate being greater, compared to a case where extent of the banding is less than the threshold value, the minimum value V1 being greater than the minimum value V2 of the use-permission rate R2. That is, the liquid ejecting apparatus 1 performs switching from the mask previously selected to a mask with a dryness-resistant extent lowered by one extent as compared with the previously selected mask. On the other hand, in a case where the liquid ejecting apparatus 1 determines in the step S91 that the extent of the banding is less than the threshold value (step S91: NO), the liquid ejecting apparatus 1 does not change the mask (step S93).

By executing such an operation, in a case where the extent of the banding detected from the print image in the joint area is great, the liquid ejecting apparatus 1 selects the mask in which the ratio regarding the change in the use-permission rate is greater, compared to a case where the extent of the banding is small. With this, further standing out of the deterioration in the image quality due to the banding, which might be caused by selecting the mask with the high dryness-resistant extent in a case where the banding occurs, can be reduced.

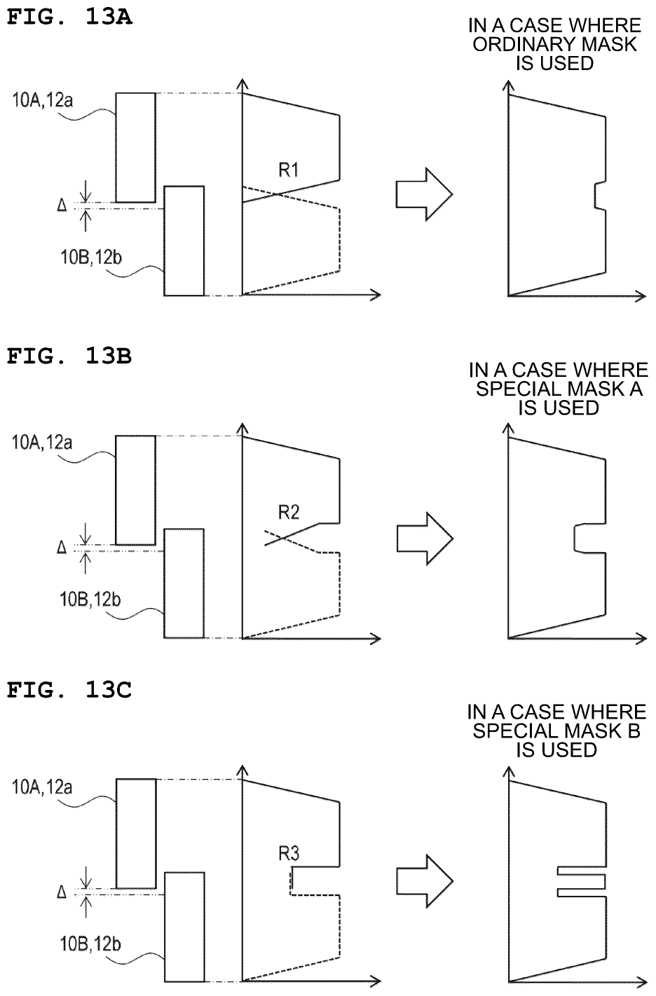

FIGS. 13A to 13C are each a schematic view for describing the kind of mask and the conspicuousness of banding in a case where the banding is present in the joint area due to deviation by distance Δ in the front-rear direction between the first ejection head 10A and the second ejection head 10B. FIG. 13A depicts a case where the ordinary mask is used, FIG. 13B depicts a case where the special mask A is used, and FIG. 13C depicts a case where the special mask B is used. Note that the ordinary mask has the dryness-resistant extent which is “low” and the banding-resistant extent which is “high”. The special mask A has the dryness-resistant extent which is “medium” and the banding-resistant extent which is also “medium”. The special mask B has the dryness-resistant extent which is “high” and the banding-resistant extent which is “low”.

Further, in the left portion of each of FIG. 13A to FIG. 13C, a concept of disposing the first special color head 12a and the second special color head 12b is depicted. Furthermore, in the center of each of FIG. 13A to FIG. 13C, a graph depicting the use-permission rate (0% to 100%) of the nozzles 14 at each position in the front-rear direction is depicted, with the vertical axis representing the positions of the nozzles 14 in the front-rear direction and the horizontal axis representing the use-permission rate. Moreover, in this graph, an upper graph in solid line corresponds to the first special color head 12a, and a lower graph in dashed line corresponds to the second special color head 12b. Further, in the right portion of each of FIG. 13A to FIG. 13C, a graph depicting the total amount of the use-permission rates of the nozzles 14 at each position in the front-rear direction is indicated with respect to the first special color head 12a and the second special color head 12b.

With respect to the ordinary mask depicted in FIG. 13A, the dryness-resistant extent is low but the banding-resistant extent is high, and as compared with the special mask A and special mask B, the change in the use-permission rate of the nozzles 14 is smaller even in a case where the banding occurs. With respect to the special mask A depicted in FIG. 13B, the dryness-resistant extent is medium and thus the special mask A contributes more to the countermeasure against the dryness as compared with the ordinary mask. However, as appreciated from the comparison between the graphs on the right portion of FIG. 13A and FIG. 13B, in a case where the banding occurs, the change in the use-permission rate of the nozzles 14 is greater in the special mask A than in the ordinary mask, leading to a such a concern that the image quality might deteriorate.

In the case of the special mask B depicted in FIG. 13C, the dryness-resistant extent is high, and thus the special mask B contributes most to the countermeasure against the dryness. However, as appreciated from the comparing of the graph on the right of FIG. 13C with the graphs on the right portions of FIG. 13A and FIG. 13B, in a case where the banding occurs, the change in the use-permission rate of nozzles 14 is greater compared to the ordinary mask and the special mask A, leading to such a concern that the image quality might deteriorate significantly.

In view of the above-described situations, in this embodiment, the mask which has been selected from the viewpoint of the countermeasure against the dryness is reconsidered from the viewpoint of the countermeasure against the banding. Further, in a case where the extent of the banding is of a certain extent or more (in a case where the banding is likely to be conspicuous), the currently-used mask is exchanged with the mask with the dryness-resistant extent one step lower (in other words, the currently-used mask is exchanged with the mask with the banding-resistant extent raised one step higher). With this, the countermeasure against the dryness and the countermeasure against the banding can be performed in a well-balanced manner.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Note that in the foregoing description, the liquid ejecting apparatus 1 is exemplified as having the configuration wherein the same kind of liquid is ejected using the two ejection heads 10A and 10B and one joint area is formed between the two ejection heads 10A and 10B. However, the present disclosure is not limited to this configuration. For example, the present disclosure is also applicable to a liquid ejecting apparatus in which the same kind of liquid is ejected using three or more ejection heads and a total of two or more joint areas are formed among these three or more ejection heads.

What is claimed is:

1. A liquid ejecting apparatus comprising:
a first ejection head having a plurality of first nozzles;
a second ejection head having a plurality of second nozzles;
a conveyor, a recording medium being conveyed by the conveyor in a conveyance direction with respect to the first ejection head and the second ejection head;
a carriage, the first ejection head and the second ejection head being moved by the carriage in a movement direction crossing the conveyance direction; and
a controller, wherein:
the first ejection head and the second ejection head are disposed so that a part of the plurality of first nozzles and a part of the plurality of second nozzles overlap with each other in the conveyance direction in a joint area;
the controller is configured to execute:
a risk obtaining process of obtaining information on drying risk of a liquid in the part of the plurality of first nozzles and the part of the plurality of second nozzles;
a mask selecting process of selecting one mask of a plurality of masks depending on the drying risk; and
a printing process of performing printing based on a print job by using the selected one mask;
each of the plurality of masks defines a first ratio and a second ratio;
the first ratio is a ratio of increasing toward a first side in the conveyance direction of a first use-permission rate, the first use-permission rate being a rate of a number of a nozzle to be used in ejecting of the liquid in a row to a number of the first nozzles arranged in the moving direction in the row, the first nozzles being included in the part of the plurality of first nozzles;
the second ratio is a ratio of decreasing toward the first side in the conveyance direction of a second use-permission rate, the second use-permission rate being a rate of a number of a nozzle to be used in ejecting of the liquid in a row to a number of the second nozzles arranged in the moving direction in the row, the second nozzles being included in the part of the plurality of second nozzles; and
the first ratio is different from each other among the plurality of masks, and the second ratio is different from each other among the plurality of masks.

2. The liquid ejecting apparatus according to claim 1, wherein the controller is configured to select a mask with the first ratio and the second ratio being smaller as the drying risk is greater, the mask being included in the plurality of masks.

3. The liquid ejecting apparatus according to claim 2, wherein:
the controller is configured to execute a flushing process of discharging the liquid from the plurality of first nozzles and the plurality of second nozzles;
the controller is configured to execute a determination process of determining whether an elapsed time since the flushing process executed last time has exceeded a first period; and
in the mask selecting process and in a case where the elapsed time since the flushing process executed last time has exceeded the first period, the controller is configured to select a mask with the first ratio and the second ratio being smaller compared to a case where the elapsed time has not exceeded the first period, the mask being included in the plurality of masks.

4. The liquid ejecting apparatus according to claim 2, wherein:
the plurality of masks includes at least an ordinary mask and a special mask, the first ratio and the second ratio of the special mask being smaller than the first ratio and the second ratio of the ordinary mask;
the controller is configured to execute a determination process of determining whether a printing period using the ordinary mask has exceeded a second period; and
in the mask selecting process, the controller is configured to select the special mask, in a case where the printing period using the ordinary mask has exceeded the second period.

5. The liquid ejecting apparatus according to claim 2, wherein:
the controller is configured to execute a pass printing process of executing an ejecting operation and a conveying operation, the controller causing, in the ejecting operation, the first ejection head and the second ejection head to eject the liquid while causing the carriage to move the first ejection head and the second ejection head in the movement direction, the controller causing, in the conveying operation, the conveyor to convey the recording medium in the conveyance direction;
the controller is configured to execute a determination process of determining whether an ejection amount of the liquid in a next pass in the pass printing process is a first threshold value or more; and
in the mask selecting process and in a case where an ejection amount of the liquid in the next pass in the pass printing process is the first threshold value or more, the controller is configured to select a mask with the first ratio and the second ratio being smaller compared to a case where the ejection amount of the liquid in the next pass is less than the first threshold value, the mask being included in the plurality of masks.

6. The liquid ejecting apparatus according to claim 2, wherein:
the controller is configured to execute a pass printing process of executing an ejecting operation and a conveying operation, the controller causing, in the ejecting operation, the first ejection head and the second ejection head to eject the liquid while causing the carriage to move the first ejection head and the second ejection head in the movement direction, the controller causing, in the conveying operation, the conveyor to convey the recording medium in the conveyance direction;
the controller is configured to execute a determination process of determining whether an ejection amount of the liquid in a next pass in the pass printing process is less than a second threshold value; and
in the mask selecting process and in a case where the ejection amount of the liquid in the next pass in the pass printing process is less than the second threshold value, the controller is configured to select a mask with the first ratio and the second ratio being smaller compared to a case where the ejection amount of the liquid in the next pass is the second threshold value or more, the mask being included in the plurality of masks.

7. The liquid ejecting apparatus according to claim 2, wherein the controller is configured to:
execute a pass printing process of executing an ejecting operation and a conveying operation, the controller causing, in the ejecting operation, the first ejection head and the second ejection head to eject the liquid while causing the carriage to move the first ejection head and the second ejection head in the movement direction, the controller causing, in the conveying operation, the conveyor to convey the recording medium in the conveyance direction; and
execute the mask selecting process, during executing of the print job, before starting of the pass printing process to a single pass or after ending of the pass printing process to a single pass.

8. The liquid ejecting apparatus according to claim 2 comprising a temperature sensor, information on temperature around the first ejection head and the second ejection head being detected by the temperature sensor,
wherein in the mask selecting process and in a case where the temperature is a threshold value or more, the controller is configured to select a mask with the first ratio and the second ratio being smaller compared to a case where the temperature is less than the threshold value, the mask being included in the plurality of masks.

9. The liquid ejecting apparatus according to claim 2 comprising a humidity sensor, information on humidity around the first ejection head and the second ejection head being detected by the humidity sensor,
wherein in the mask selecting process and in a case where the humidity is less than a threshold value, the controller is configured to select a mask with first ratio and the second ratio being smaller compared to a case where the humidity is the threshold value or more, the mask being included in the plurality of masks.

10. The liquid ejecting apparatus according to claim 2 comprising a temperature sensor, information on temperature around the first ejection head and the second ejection head being detected by the temperature sensor, wherein
in the mask selecting process, the controller is configured to change a standard for selecting the mask with the first ratio and the second ratio being smaller depending on a result of detection by the temperature sensor.

11. The liquid ejecting apparatus according to claim 2 comprising a humidity sensor, information on humidity around the first ejection head and the second ejection head being detected by the humidity sensor, wherein
in the mask selecting process, the controller is configured to change a standard for selecting the mask with the first ratio and the second ratio being smaller depending on a result of detection by the humidity sensor.

12. The liquid ejecting apparatus according to claim 1, wherein:
the first ejection head includes a first color head and a first special color head, a process color ink being ejected from the first color head as the liquid, a special color ink being ejected from the first special color head as the liquid;
the second ejection head includes a second color head and a second special color head, the process color ink being ejected from the second color head as the liquid, the special color ink being ejected from the second special color head as the liquid;
the joint area includes a color joint area between the first color head and the second color head, and a special color-joint area between the first special color head and the second special color head; and
in the mask selecting process and in a case where the print job includes the printing process in the special color-joint area, the controller is configured to select a mask with the first ratio and the second ratio being smaller compared to a case where the print job does not include the printing process in the special color-joint area, the mask being included in the plurality of masks.

13. The liquid ejecting apparatus according to claim 2, wherein:
the first ejection head and the second ejection head are configured to eject a small droplet and a large droplet; and
in a case where a rate of an occasion where the liquid to be ejected in the joint area in the printing process is a small droplet is a threshold value or more in the print job, the controller is configured to select a mask with the first ratio and the second ratio being smaller compared to a case where the rate is less than the threshold value, the mask being included in the plurality of masks.

14. The liquid ejecting apparatus according to claim 1, wherein:
the controller is configured to execute a banding detecting process of detecting a banding in a print image caused by a deviation in a relative position between the first ejection head and the second ejection head; and
in the mask selecting process and in a case where an extent of the banding detected from the print image in the joint area is a threshold value or more, the controller is configured to select a mask with the first ratio and the second ratio being greater compared to a case where the extent of the banding is less than the threshold value, the mask being included in the plurality of masks.

15. The liquid ejecting apparatus according to claim 1, wherein:
the controller is configured to execute a non-ejection detecting process of detecting whether a non-ejection nozzle is present in the part of the plurality of first nozzles or the part of the plurality of second nozzles;
in a case where the controller determines the non-ejection nozzle in a first one of the part of the plurality of first nozzles and the part of the plurality of second nozzles is present, the controller is configured to select, in the mask selecting process and with respect to the joint area, a mask using only a second one of the part of the plurality of first nozzles and the part of the plurality of second nozzles; and
the second one of the part of the plurality of first nozzles and the part of the plurality of second nozzles is different from the first one of the part of the plurality of first nozzles and the part of the plurality of second nozzles.

16. The liquid ejecting apparatus according to claim 15, wherein the controller is configured to select the mask using only the second one of the part of the plurality of first nozzles and the part of the plurality of second nozzles, before executing the printing process.

17. A liquid ejecting method using a liquid ejecting apparatus,
the liquid ejecting apparatus including:
a first ejection head having a plurality of first nozzles;
a second ejection head having a plurality of second nozzles;
a conveyor, a recording medium being conveyed by the conveyor in a conveyance direction with respect to the first ejection head and the second ejection head;
a carriage, the first ejection head and the second ejection head being moved by the carriage in a movement direction crossing the conveyance direction; and
a controller,
wherein the first ejection head and the second ejection head are disposed so that a part of the plurality of first nozzles and a part of the plurality of second nozzles overlap with each other in the conveyance direction in a joint area,
the liquid ejecting method comprising:
obtaining information on drying risk of a liquid in the part of the plurality of first nozzles and the part of the plurality of second nozzles;
selecting one mask of a plurality of masks depending on the drying risk; and
performing printing based on a print job by using the selected one mask, wherein:
each of the plurality of masks defines a first ratio and a second ratio;
the first ratio is a ratio of increasing toward a first side in the conveyance direction of a first use-permission rate, the first use-permission rate being a rate of a number of a nozzle to be used in ejecting of the liquid in a row to a number of the first nozzles arranged in the moving direction in the row, the first nozzles being included in the part of the plurality of first nozzles;
the second ratio is a ratio of decreasing toward the first side in the conveyance direction of a second use-permission rate, the second use-permission rate being a rate of a number of a nozzle to be used in ejecting of the liquid in a row to a number of the second nozzles arranged in the moving direction in the row, the second nozzles being included in the part of the plurality of second nozzles; and
the first ratio is different from each other among the plurality of masks, and the second ratio is different from each other among the plurality of masks.

18. A non-transitory and computer-readable medium storing a program executable by a controller in a liquid ejecting apparatus,
the liquid ejecting apparatus including:
a first ejection head having a plurality of first nozzles;
a second ejection head having a plurality of second nozzles;
a conveyor, a recording medium being conveyed by the conveyor in a conveyance direction with respect to the first ejection head and the second ejection head;
a carriage, the first ejection head and the second ejection head being moved by the carriage in a movement direction crossing the conveyance direction; and
the controller,
wherein the first ejection head and the second ejection head are disposed so that a part of the plurality of first nozzles and a part of the plurality of second nozzles overlap with each other in the conveyance direction in a joint area,
the program is configured to cause the controller to:
obtain information on drying risk of a liquid in the part of the plurality of first nozzles and the part of the plurality of second nozzles;
select one mask of a plurality of masks depending on the drying risk; and
perform printing based on a print job by using the selected one mask, wherein:
each of the plurality of masks defines a first ratio and a second ratio;
the first ratio is a ratio of increasing toward a first side in the conveyance direction of a first use-permission rate, the first use-permission rate being a rate of a number of a nozzle to be used in ejecting of the liquid in a row to a number of the first nozzles arranged in the moving direction in the row, the first nozzles being included in the part of the plurality of first nozzles;
the second ratio is a ratio of decreasing toward the first side in the conveyance direction of a second use-permission rate, the second use-permission rate being a rate of a number of nozzle to be used in ejecting of the liquid in a row to a number of the second nozzles arranged in the moving direction in the row, the second nozzles being included in the part of the plurality of second nozzles; and
the first ratio is different from each other among the plurality of masks, and the second ratio is different from each other among the plurality of masks.
